(19) United States
(12) Patent Application Publication
(10) Pub. No.: US 2016/0048908 A1
(43) Pub. Date: Feb. 18, 2016

(54) INTERACTIVE COMPUTER NETWORK SYSTEM AND METHOD

(71) Applicants: Bassam Sibai, Mississauga (CA); Hamze Sibai, Mississauga (CA)

(72) Inventors: Bassam Sibai, Mississauga (CA); Hamze Sibai, Mississauga (CA)

(21) Appl. No.: 14/824,117

(22) Filed: Aug. 12, 2015

Related U.S. Application Data
(60) Provisional application No. 62/037,284, filed on Aug. 14, 2014.

(51) Int. Cl. G06Q 30/06; G06Q 30/02

(52) U.S. Cl. CPC G06Q 30/0643; G06Q 30/0207

(57) ABSTRACT

A computer-based virtual interactive global marketplace system may facilitate the sale, over a network, of a real product or service by a seller to a buyer having access to a client device. The system may allow the buyer to customize the product or service and interact with digital non-playing characters to learn about the product or service.

### CROSS-REFERENCE TO RELATED APPLICATIONS

The present application claims priority to U.S. Provisional Patent Application No. 62/037,284, filed Aug. 14, 2014, the contents of which are hereby incorporated herein by reference.

### FIELD

The present application relates generally to commerce and, more specifically, to selling an item in an interactive marketplace over a computer network.

### BACKGROUND

The Internet has become a popular venue for the marketing and sale of goods and services in recent years. Websites such as Kijiji™, Craigslist™ and Ebay™ offer a convenient forum for online retail. Websites such as these are often used for the sale of simple goods, such as furniture and electronics, which only require textual and/or pictorial descriptions to provide the information necessary to promote the sale of the product. These websites lack the functionality necessary to facilitate the sale of more complex goods, such as real estate properties and vehicles. For example, the sale of a home often requires more than simple textual information. Impelling the sale of such items often requires a degree of interactivity to evoke the imagination of the prospective purchaser with respect to the possible uses or customizations of the product. For instance, the sale of a home is often facilitated by “open houses” wherein real estate agents provide guided tours and stage the home to improve its appearance and to allow the prospective buyer to visualize the potential of the property. Such interaction and customization is not provided for in present online retail solutions.

### SUMMARY

A computer-based virtual interactive global marketplace system may facilitate the sale, over a network, of a real product or service by a seller to a buyer having access to a client device.

According to an aspect of the present disclosure, there is provided a server in a computer-based interactive marketplace system for the sale, over a network, of an item by a seller to a buyer having access to a buyer client device. The server is adapted to generate a digital representation of the item, generate a digital environment, the virtual environment accessible by the buyer over the network by a buyer client interface executed on the buyer client device, the virtual environment comprising the digital representation of the item, manipulate, in accordance with first instructions received via the buyer client interface, the virtual environment, generate, in accordance with second instructions received via the buyer client interface, a digital buyer avatar representative of the buyer, the digital buyer avatar for navigating the digital environment, allow for digital interaction, in accordance with third instructions received via the buyer client interface, between the digital buyer avatar and the digital environment and carry out a purchase-related action, in accordance with fourth instructions received via the buyer client interface.

According to another aspect of the present disclosure, there is provided a method for offering for sale, over a network, a real product or service by a seller to a buyer having access to a client device. The method includes receiving, at a server, first item-related instructions, generating, at the server and according to the first item-related instructions, a digital representation of an item, receiving, at a server, environment-related instructions and generating, at the server and according to the environment-related instructions, a digital environment. The digital environment is arranged to present the digital representation of the item, receive second item-related instructions from a buyer client interface executed on a buyer client device and alter, at the server and according to the second item-related instructions, the digital representation of the item. In other aspects of the present application, a server having a processor is provided for carrying out this method and a computer readable medium is provided for adapting a processor in a server to carry out this method.

Other aspects and features of the present disclosure will become apparent to those of ordinary skill in the art upon review of the following description of specific implementations of the disclosure in conjunction with the accompanying figures.

### BRIEF DESCRIPTION OF THE DRAWINGS

Reference will now be made, by way of example, to the accompanying drawings which show example implementations; and in which:

FIG. 1 illustrates example elements of a marketplace system including a server, a buyer client device and seller client device in accordance with an aspect of the present application;

FIG. 2 illustrates example steps in a method of operating the server of FIG. 1 in accordance with an aspect of the present application;

FIG. 3 illustrates a first example client interface in three dimensions in third person perspective in accordance with an aspect of the present application;

FIG. 4 illustrates a third example client interface in three dimensions in first person perspective in accordance with an aspect of the present application;

FIG. 5 illustrates a third example client interface in two dimensions in accordance with an aspect of the present application;

FIG. 6 schematically illustrates activity related to a virtual asset marketplace aspect of the present application;

FIG. 7 illustrates a digital non-playing character prompting a digital buyer avatar to view a video in accordance with an aspect of the present application;

FIG. 8 illustrates a scenario in which a video may be played passively on a virtual screen in accordance with an aspect of the present application;

FIG. 9 illustrates a scenario in which a video may be played in a “full-screen” mode in accordance with an aspect of the present application;

FIG. 10 illustrates a scenario in which a video may be played in a media player window in accordance with an aspect of the present application;

FIG. 11 illustrates a seller overview interface in accordance with an aspect of the present application;

FIG. 12 schematically illustrates seller activities related to the setting up of a store in accordance with an aspect of the present application;

FIG. 13 schematically illustrates seller activities related to managing a store in accordance with an aspect of the present application;

FIG. 14 schematically illustrates potential buyer paths followed in the marketplace of FIG. 1 in accordance with an aspect of the present application;

FIG. 15 illustrates example buyer activity related to shopping in a virtual environment in accordance with an aspect of the present application; and

FIG. 16 illustrates example buyer activity related to shopping in a virtual environment after the buyer has entered the selected store's virtual environment in accordance with an aspect of the present application.

### DETAILED DESCRIPTION

In overview, aspects of the present application relate to a computer-based, virtual, interactive, global marketplace system for the sale, over a network, of a real product or service by a seller to a buyer, wherein the buy has access to a client device. Within this disclosure, the term “real product” may refer to a product, in the real world, that is being sold within the virtual interactive global marketplace system and, as such, has a digital representation within the system that is separate and distinct from the real product that is external to the system.

The virtual, interactive, global marketplace system allows sellers/advertisers and consumers to interact in a digital, virtual environment to facilitate the buying and selling of goods and services. It is expected that the system may allow prospective purchasers to view, interact with, and customize aspects of the virtual environment, including digital representations of the goods or services being sold, in ways not practical to accomplish in the real world, in real-time, in order facilitate the decision-making process of the prospective purchasers.

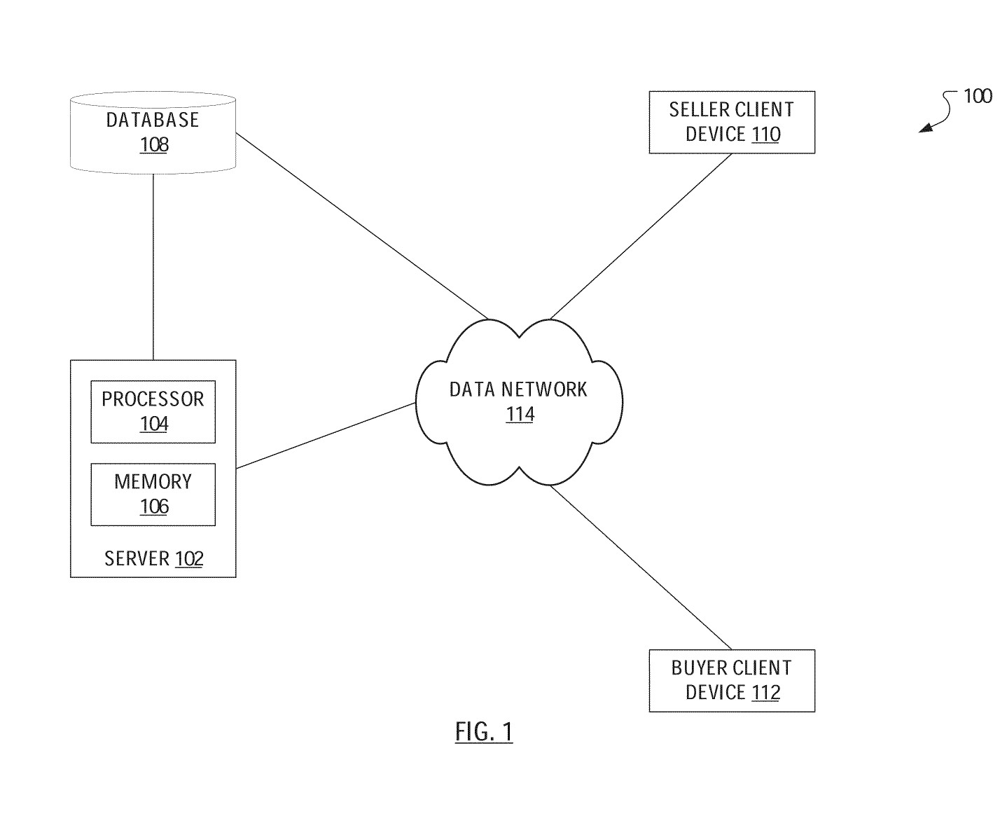

FIG. 1 illustrates example elements of a marketplace system 100. The marketplace system 100 comprises a client-server architecture, wherein seller listings are stored in one or more databases and are served from one or more servers and accessed by client devices via respective client interfaces. The marketplace system 100 is illustrated, in FIG. 1, as including a server 102 that is representative of the one or more servers. The server 102 is illustrated as including a processor 104 and a memory 106 as well as maintaining a connection to a database 108 that is representative of the one or more databases. The marketplace system 100 is illustrated, in FIG. 1, as including a seller client device 110 that is representative of one or more seller client devices and a buyer client device 112 that is representative of one or more buyer client devices.

The server 102 and the client devices 110, 112 communicate over a network 114. Stand-alone client software may be used to provide functionality at the client devices 110, 112. In aspects of the present application, the server 102 may be globally accessible to persons with access to the present-day Internet (and successor networks). Accordingly, a client interface presented at the client devices 110, 112 may be a “thin client,” such as an existing web browser. That is, the seller client device 110 may execute a web browser. Interaction between the web browser and the server 102 may allow for interaction between the seller and the server 102. Similarly, the buyer client device 112 may execute a web browser to allow for interaction between the buyer and the server 102. The server 102 may generate a client-specific instance of a virtual environment for each specific buyer, so that one buyer's interactions or customizations with an environment do not impact another buyer's experience within that environment.

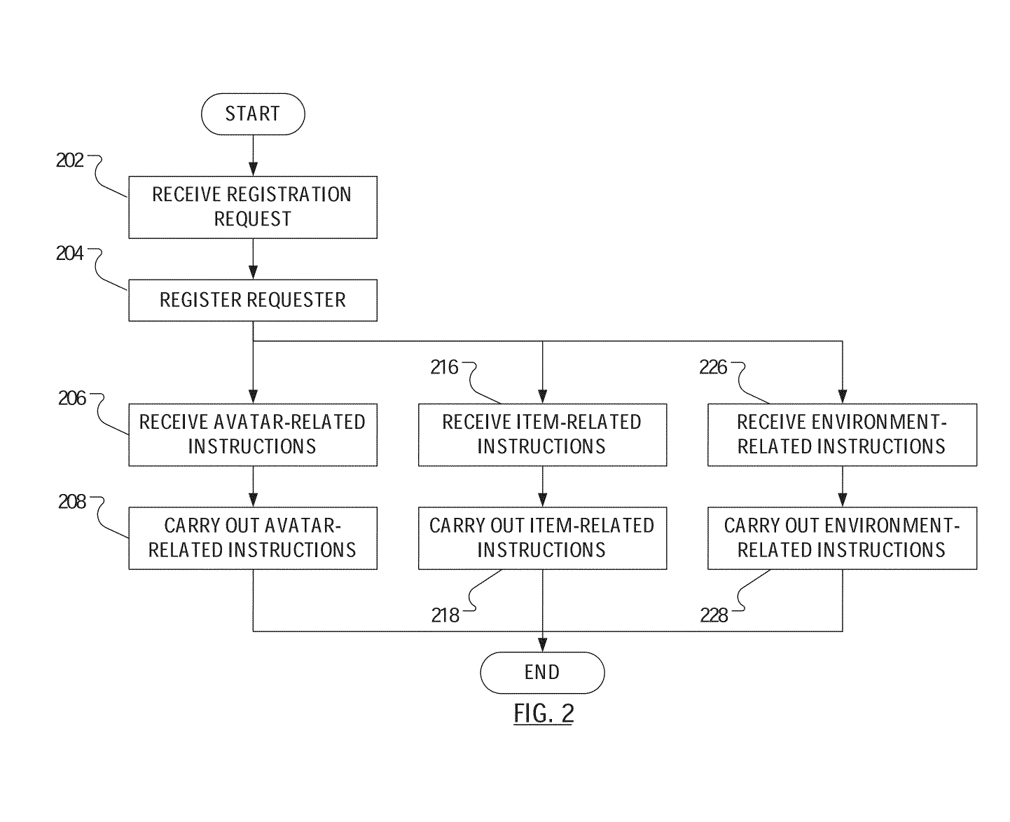

FIG. 2 illustrates example steps in a method of operating the server 102. In view of FIG. 2, responsive to receiving (step 202) a registration request along with seller information, a username and a password, the server 102 may store such information securely in the database 108. Having stored the appropriate information, the server 102 may be considered to have registered (step 204) the seller.

The server 102 may include a combination of software and hardware suitable for allowing a seller to generate a digital representation of a real product or service (often referenced herein as an “item”). The server 102 may, responsive to receiving (step 216) item-related instructions, carry out (step 218) the item-related instructions. Such instructions may include instructions to generate a digital representation of an item.

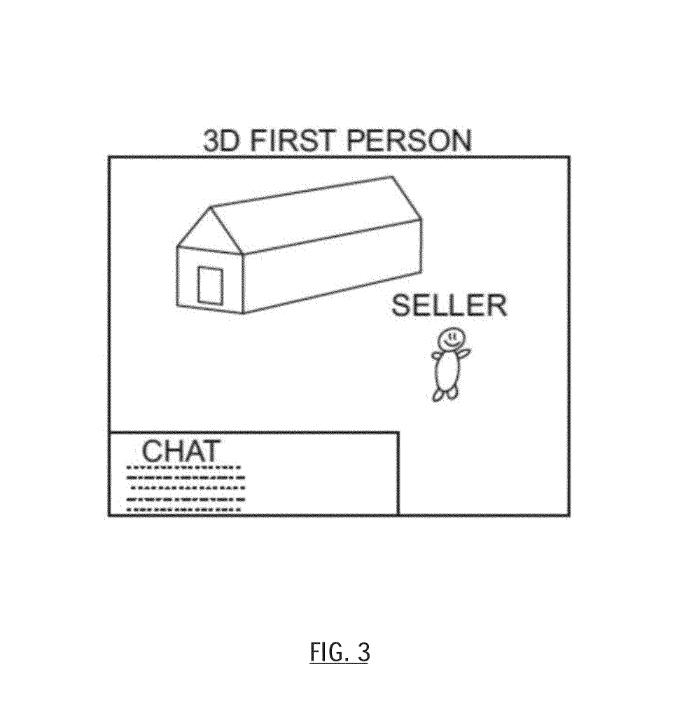

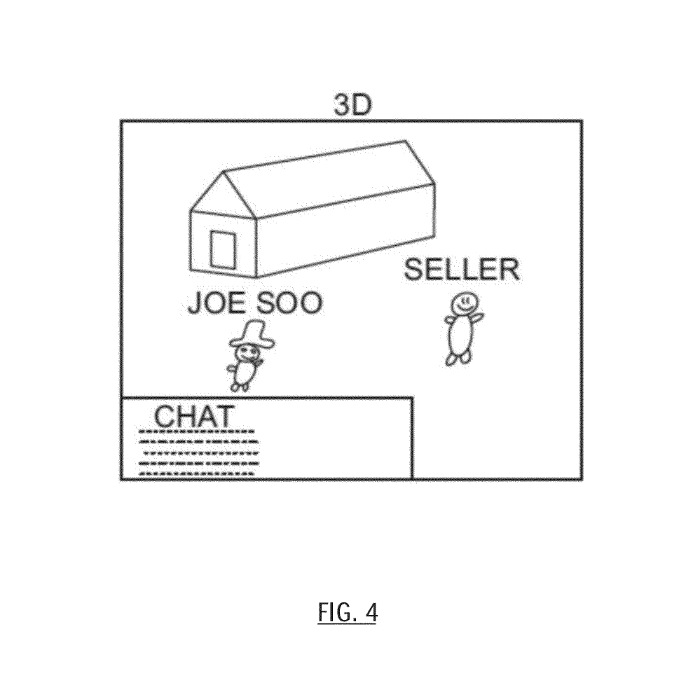

For many types of products, and especially for real estate properties such as residential homes, the digital representation of the item may be a three-dimensional (3D) digital rendering of the real product (see FIGS. 3 and 4). Known software products may be used to generate a three-dimensional (3D) rendering from two dimensional photographs of the real product. One such software product is 3-sweep™ from 3D Printing Systems of Australia. Another such software product is Make3D from Cornell University in Stanford, Calif. Another such software product is insight3d, which is open-source educational software. As will be discussed hereinafter in further detail, the digital representation may also be a two-dimensional (2D) representation of the real product, a 2D graphical projection of the real product (2.5D) or a text description of the real product.

The server 102 may further comprises a combination of software and hardware suitable for use, by the seller, to generate one or more digitally interactive virtual environments on the server 102. The server 102 may, responsive to receiving (step 226) environment-related instructions, carry out (step 228) the environment-related instructions. Such instructions may include instructions to generate one or more digitally interactive virtual environment. Each virtual environment may comprise one or more digital representations of respective one or more real products or services (items) being sold by the seller. Each virtual environment may be accessed over the network by multiple buyers using the system, via the client interfaces on their respective client devices. A product being sold on the system 100 is associated with a digital virtual environment.

A virtual environment may be defined as a 2D or 3D environment in which real-time interaction between the buyer and the environment may take place. If the seller is logged into the system, real-time interaction between the buyer and the seller may also take place.

The system 100 further comprises a combination of software and hardware suitable to allow for digital manipulation of the virtual environment on the server 102 by the seller. Such digital manipulation may take the form of the seller altering various attributes of one or more of the seller's environments. For example, a seller named “Joe” may have a virtual environment that is a virtual 3D retail shop. Joe may exercise the ability for digital manipulation of the virtual environment by altering attributes of the environment, such as the name of the shop (e.g., “Joe's Comic Book Heaven”), the appearance of the shop (e.g., wall colors, signage style, etc.) or a text description of the environment. Furthermore, digital manipulation may relate to Joe tagging or associating the environment with one or more “item types” that Joe would like to sell within the environment to buyers over the network (e.g., Comic books, Trading cards, Video Games, etc.).

In operation, each buyer generates a buyer profile to establish an ability to use the system. The buyer profile typically comprises biographical information specific to the buyer, such as the buyer's date of birth, and/or non-biographical information specific to the buyer, such as a user name and a password. The user name and password may be employed for identification and authentication so that the buyer may gain access to the system.

FIG. 2 illustrates example steps in a method of operating the server 102. Responsive to receiving (step 202) a registration request along with buyer information, the username and the password, the server 102 may store such information securely in the database 108. Having stored the appropriate information, the server 102 may be considered to have registered (step 204) the buyer.

The server 102 further comprises a combination of software and hardware suitable to allow for generation, by the buyer via the client interface, of a digital buyer avatar. Each buyer has control over the digital buyer avatar and may manipulate aspects of the digital buyer avatar. Aspects of the digital buyer avatar that may be manipulated may include appearance, style of movement, capabilities (e.g., the digital buyer avatar may be able to fly), voice sound. Where there is a 3D virtual environment, the system may be configured to allow the buyer to navigate the virtual environment using the digital buyer avatar.

The server 102 may, responsive to receiving (step 206) avatar-related instructions, carry out (step 208) the avatar-related instructions. Such instructions may include instructions to generate a new digital buyer avatar or alter an existing digital buyer avatar. Accordingly, the server 102 may carry out (step 208) the avatar-related instructions by generating a digital buyer avatar according to the instructions. Alternatively, the server 102 may carry out (step 208) the avatar-related instructions by altering a digital buyer avatar according to the instructions.

The system 100 may further comprise a combination of software and hardware that allow for digital interaction between the buyer and an environment, over the network 114. The hardware may include a mouse (not shown) in communication with the buyer client device 112 allowing the buyer to select from among selectable icons associated with the environment (e.g., for selecting a purchase-related action, such as a purchase or an offer, or for changing a color of a selected component, such as a wall, of a virtual 3D rendering of, e.g., a home being sold within the environment). The digital interaction between the buyer and the virtual environment may take the form of text input into an online chat box (not shown) presented at the buyer client device 112 and associated with the environment. Through use of the online chat box. The buyer may chat with the seller and/or other buyers. The hardware may include a microphone (not shown) and a speaker (not shown) in communication with the buyer client device 112 allowing for digital interaction between the buyer and the environment to take the form of audio communication. The audio communication may, for example, be between the buyer and the seller and/or between the buyer and other buyers.

The system 100 may further comprise a combination of software and hardware at the seller client device 110 that allow for digital interaction between the seller and one or more other sellers, such as by digital text or audio communication over the network 114, as described hereinbefore.

Each buyer client device 112 may be provided with a combination of software and hardware that allow the buyer to perform a purchase-related action over the network 114, via the client interface. The hardware may, for example, take the form of a mouse (not shown) in communication with the buyer client device 112 allowing the buyer to select an icon from among selectable icons or a menu item from among a drop-down menu. The purchase-related action may be an offer to purchase at a price suggested by the buyer or an offer to purchase at the seller's sale price as specified in the listing. Other purchase-related actions may be available to the buyer, e.g., an offer to meet the seller in person.

The combination of software and hardware that allow for digital manipulation of the virtual environment on the server 102 by the seller may, for example, allow the seller to customize the set of purchase-related actions. In this way, the seller has control over the options available to buyers within the seller's virtual environments. Such customization may be made with respect to an entire virtual environment, with respect to all of a seller's virtual environments or on a per product basis. A purchase using the system may be made by known methods, such as payment methods made available by PayPal of San Jose, Calif. For another, non-exhaustive example, a purchase using the system may also be made using a secure online credit card transaction.

The combination of software and hardware that allow for digital manipulation of the virtual environment on the server 102 by the seller may, for example, allow the seller to generate a digital seller avatar on the server.

Returning to FIG. 2, the server 102 may, responsive to receiving (step 206) avatar-related instructions, carry out (step 208) the avatar-related instructions. Such instructions may include instructions to generate a new digital seller avatar or alter an existing digital seller avatar. Accordingly, the server 102 may carry out (step 208) the avatar-related instructions by generating a digital seller avatar according to the instructions. Alternatively, the server 102 may carry out (step 208) the avatar-related instructions by altering a digital seller avatar according to the instructions.

Subsequent to the generation (step 028) of the digital seller avatar, the virtual environment may be seen to comprise the digital seller avatar, the virtual environment and product digital representations associated with the virtual environment. The digital seller avatar may be found to be present within a virtual environment selected by the seller whenever the seller is logged into the system. The seller has control over the digital seller avatar and may manipulate aspects of the digital seller avatar. The aspects of the digital seller avatar that may be manipulated may, for several examples, include appearance, style of movement, capabilities (e.g., the digital seller avatar may be able to fly) and voice sound. Where the environment includes a digital seller avatar, digital interaction between the buyer and the seller may occur as real-time digital interaction between the digital buyer avatar and the digital seller avatar over the network. In some cases, this digital interaction may comprise audio communication between the buyer and the seller, via microphone and speaker components or peripherals of the respective client devices 110, 112. In an embodiment that allows for such audio communication, the digital buyer avatar and the digital seller avatar may appear, within the virtual environment, to be engaged in a conversation. The communication between the digital buyer avatar and the digital seller avatar may, alternatively, occur in a text chat carried out via a chat window or box presented on each client interface. Such text chat interactions may be saved within the system (e.g., to a database) available to the seller and/or buyer for later review.

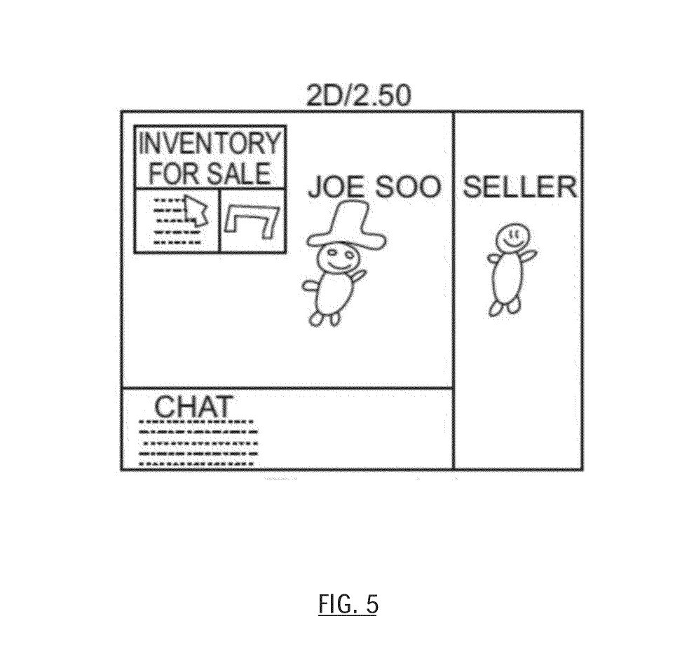

The seller and the buyer may separately choose the vantage point from which their avatar is viewed in their respective client devices 110, 112. For example, the seller may view the environment, on a display (not shown) of the seller client device 110, from a first person perspective, i.e., through the “eyes” of the digital seller avatar. Similarly, the buyer may view the environment, on a display (not shown) of the buyer client device 112, from a first person perspective, i.e., through the “eyes” of the digital buyer avatar. A 3D, first person perspective is illustrated in FIG. 3 from the vantage point of the digital buyer avatar. The buyer may, alternatively, view the environment, on a display of the buyer client device 112, from a third person perspective. A 3D, third person perspective is illustrated in FIG. 4, which perspective allows the buyer to view the digital buyer avatar within the environment. Further alternatively, the third person perspective may be presented on the display of the buyer client device 112 in a 2D format. A 2D, third person perspective is illustrated in FIG. 5.

The combination of software and hardware that allow for digital manipulation of the virtual environment on the server 102 by the seller may, for example, allow the seller to customize the environments using virtual assets. Virtual assets may be bartered or sold by a seller, over the network, to other sellers via a secondary virtual asset market within the system. In this way, the system provides two tiers of revenue generation: a first tier relating to the sale of real products to buyers, via digital representations thereof within virtual environments; and a second tier relating to the sale of virtual assets to other sellers within the system, for use within their environments to facilitate the sale of their real products. The secondary virtual asset market allows for the quick and easy digital customization of an environment, by a seller, using ready-made virtual assets, without the hassle of having to create the virtual assets. Examples of virtual assets include virtual televisions, trees, cars and furniture. Pre-made digital non-player characters (“digital NPCs”—described, hereinafter, in detail), and even virtual environments, may also be sellable or tradable virtual assets within the system. Some virtual assets used within the system may be freely available.

In an aspect of the present application, sellers may upload one or more digital data files from the seller client device 110 to the server 102. The digital data files may then be accessed, over the network 114, by buyers using their buyer client device 112 to browse a virtual environment. For example, a seller selling a home may upload a series of digital images of the home to the server 102. The seller may then have the option to digitally manipulate the environment, e.g., by including a virtual television within the home and editing the environment to play a slideshow of the uploaded files on the virtual television. Other types of files may also be uploaded, such as audio files (e.g., music to be played within the environment, or perhaps within a 3D rendering of a home within the environment), image files that may, e.g., be displayed on a virtual billboard within the environment.

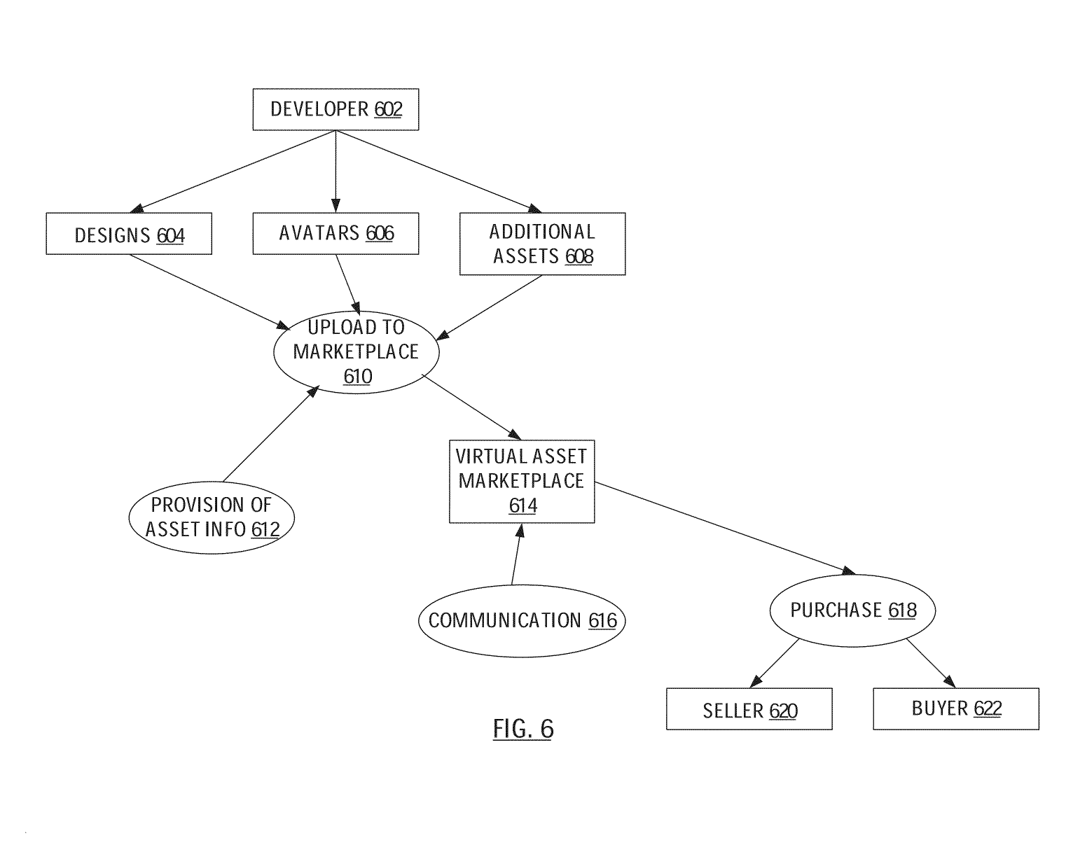

FIG. 6 schematically illustrates activity related to a virtual asset marketplace aspect of the present application. In particular, a developer 602 may create designs 604 that may be used in virtual stores. Examples of designs may include, without limitation: store signs; shelving; sale posters; trees; shrubs; and statues. Furthermore, the developer 602 may create avatars 606. Such avatars 606 may be employed by a buyer as a digital buyer avatar, by a seller as a digital seller avatar or by a seller as a digital NPC. The developer 602 may also create additional assets 608, such as dialogs for digitals NPCs. The developer 602 may upload (step 610) various virtual assets 604, 606, 608 to a virtual asset marketplace 614 hosted at the server 102 (see FIG. 1).

In addition to uploading (step 610) the various virtual assets 604, 606, 608 to the virtual asset marketplace 614, the developer 602 may also provide (step 612) information related to the various virtual assets 604, 606, 608. The information may include such aspects as a price or requirements related to the various virtual assets 604, 606, 608.

Responsive to receiving (step 616) communication, the virtual asset marketplace 614 may consider that a purchase (step 618) has been made and may arrange transfer of the virtual asset to the account of the party that has made the purchase. As illustrated in FIG. 6, the party may be a seller 620 or a buyer 622.

Upon completion of the purchase (step 618) the virtual asset marketplace 614 may arrange payment to the developer 602.

The combination of software and hardware that allow for digital manipulation of the virtual environment on the server 102 by the seller may, for example, allow the seller to generate one or more digital NPCs. Digital NPCs are computer-controlled characters within an environment. Digital NPCs may be preconfigured by the seller. A seller may configure digital NPCs within one or more of the seller's environments or may decide to have no digital NPCs. Where an environment comprises one or more NPCs, the hardware and software that allow for digital interaction between the buyer and the virtual environment also comprises hardware and software that allow for digital interaction between the digital buyer avatar and the digital NPCs over the network 114.

The digital interaction may be, e.g., audible communication, text-based communication or mouse selection of a digital NPC. An example consequence of selecting a digital NPC may be that the selected NPC begins a pre-configured series of events, such as events associated with showing the digital buyer avatar around a 3D rendering of a home that is for sale within the environment. An example consequence of selecting the digital NPC again could be, e.g., that pre-configured series of events is stopped or, alternatively, paused. Other digital interactions between the digital buyer avatar and a digital NPC are, of course, well within the scope of the present disclosure.

As digital NPCs are controlled by the server 102, the digital NPCs may be preconfigured with preset question-response sets. A seller may establish the question-response sets on their own, or they may choose to use, or customize, NPC dialogues purchased from other sellers on the secondary virtual asset market within the system. Such purchased (or alternatively, bartered for, or freely obtained), customizable NPC dialogues may take the form of preconfigured question-response sets having variables within the NPC dialogues capable of being provisioned with values by the seller. A seller may acquire a set that is well-suited to the seller's environment (e.g., a realtor based question-response set for an environment in which a home is being sold). Customization of a preset question-response set, or NPC dialogue, may comprise establishing a value (e.g., an item name, a price, etc.) for each of the variables within the NPC dialogue.

An example customized NPC dialogue may, e.g., comprise the following question and answer set:

Question: “Hello there partner! Would you be interested in looking through my collection of ITEM TYPE1 ?”

Answer1: “Yes, please show me what kind of ITEM TYPE1 you have.”

Answer2: “I'm not interested in ITEM TYPE1 . . . what else you got?”

In this dialogue, the seller, having acquired this question-response set, would only need to update the ITEM TYPE1 variable with a particular value, e.g., “comic books,” so that the question would be posed by the NPC as follows: “Hello there partner! Would you be interested in looking through my collection of comic books?”

NPC dialogues available on the virtual asset market would likely contain more than a single question with two possible responses and may contain more than one customizable variable. Once a seller creates a custom NPC dialogue, the seller may save the NPC dialogue and make the NPC dialogue available on the virtual asset market for others to use freely, or upon purchase or trade. The server 102 may provide a manner for a seller to associate a given NPC dialogue with a given NPC. The manner may, for example, involve the seller using the seller client device 110 to select, from a drop-down menu associated with an NPC, from among all NPC dialogues within the seller's repository of virtual assets. Each NPC dialogue may be identified, for example, by a dialogue name configured by the seller.

The digital NPCs may be seen as having been provided to enrich and facilitate the shopping experience for each buyer. One such shopping experience enrichment may be the provision of a guided tour. Another such shopping experience enrichment may be answering questions, thereby educating prospective buyers. A further such shopping experience enrichment may involve demonstrating products or services being offered for sale within the environment. For example, the buyer may, using the buyer client device 112, select from a number of questions pre-determined by the seller. Selection of a particular one of these questions may elicit a predetermined response from a digital NPC, which may lead to more questions being available for elaboration. Examples questions include questions about price, quality, condition, availability and features of the product/service.

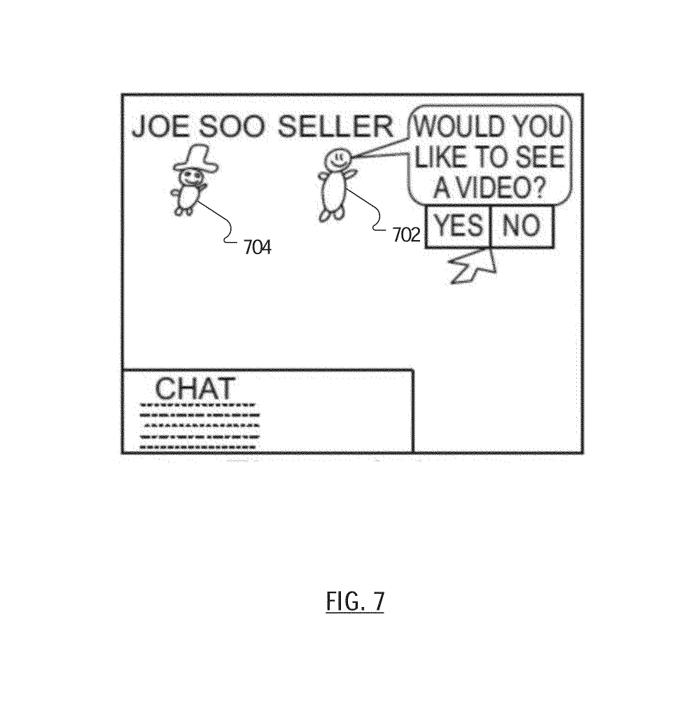

Further, the seller may customize the placement, appearance and actions of the digital NPCs. For example, a real property sale scenario could include a digital NPC working outside the 3D rendering of the home in a virtual garden, wearing gardener's apparel and giving a presentation and/or answering questions about the garden. Inside, a “realtor” digital NPC may guide potential buyers through a presentation of the various rooms of the house. Also, a digital NPC may present 2D images, videos, or 3D panoramas, e.g., of the item being offered during the interaction, the data for which is uploaded to the system by the seller as digital media data files, which may be in various formats (e.g., JPEG, MPEG, AVI, GIF). This data, or a prompt to view the data, may appear in one or more pop-up windows. In FIG. 7, a digital NPC 702 prompts a digital buyer avatar 704 to view a video.

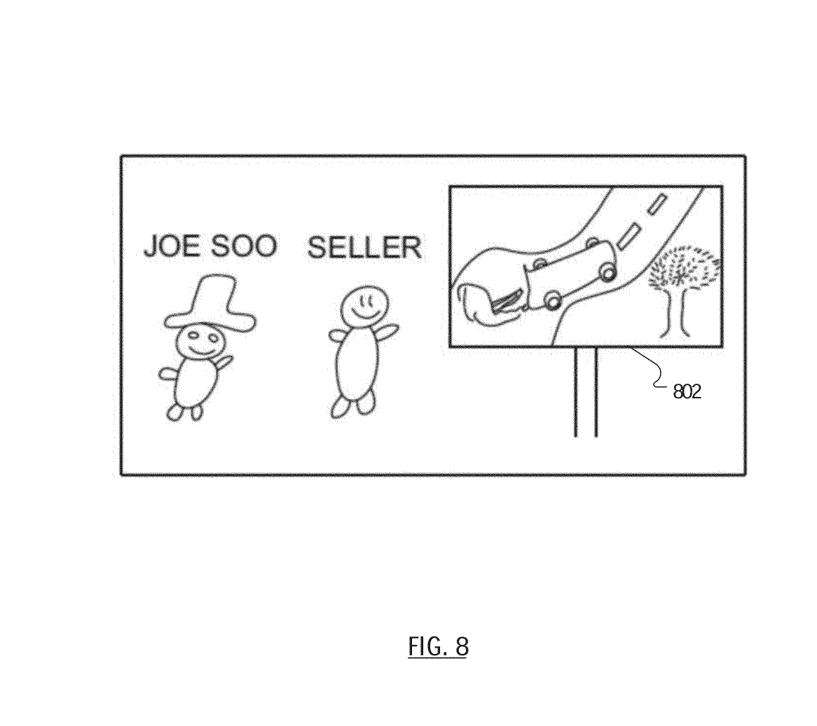

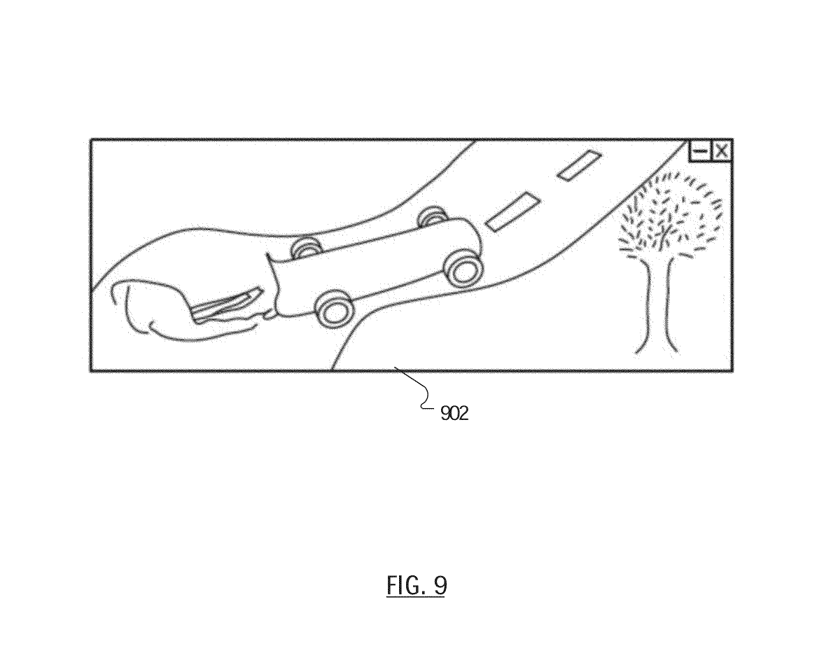

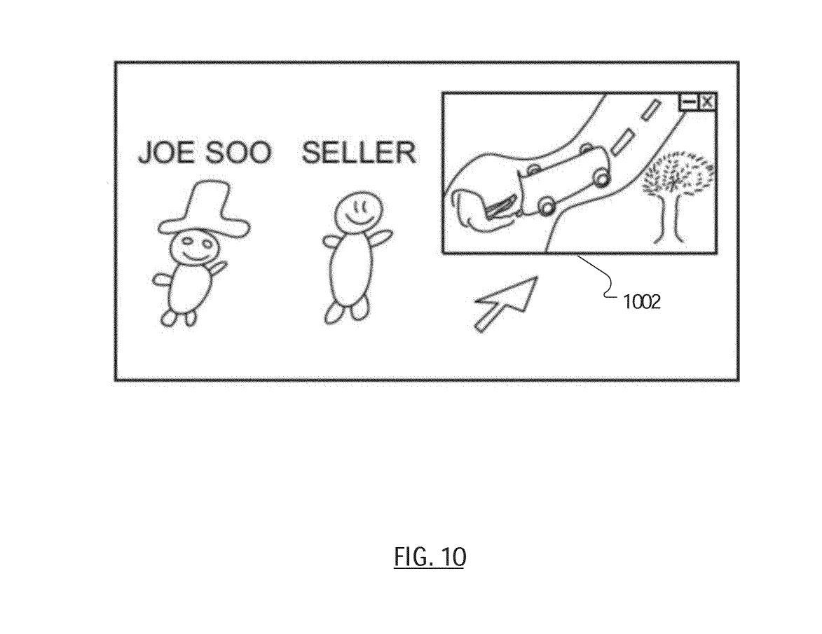

The one or more pop-up windows may be configured to appear in association with a virtual asset within the environment. For one example, illustrated in FIG. 8, a video may be played passively on a virtual screen 802, within the environment, that requires no interaction (e.g., a video billboard). For another example, illustrated in FIG. 9, a video may, responsive to the buyer having entered into a “full-screen” mode at the buyer client device 112, take up an entire screen 902 of the buyer client device 112. For a further example, illustrated in FIG. 10, a video may be played within a media player window 1002 within the client interface presented at the buyer client device 112.

Each virtual environment may be configured to have searchable attributes, e.g., a text description of the environment created by the seller (e.g. “Joe's Place”). Other searchable attributes are the descriptions of real products being sold within the environment, the types of items being sold (based on keyword tags associated with the environment by the seller), whether any sale items are being offered at a discounted price, etc. The system may be configured, such as by controlling display of a text-based search bar within the client interface presented at the buyer client device 112, to allow a buyer to search one or more of the searchable attributes, over the network 114. That is, the server 102 may receive, over the network via the buyer client interface, a search term. The server 102 may then determine a match between the search term and one of the searchable attributes of the environment.

A combination of software and hardware may allow for digital customization of the digital representation of the real product by the buyer via the client interface presented at the buyer client device 112. The server 102 may be configured so that the buyer is allowed to effect such changes over the network 114 in real-time. For example, the buyer may be browsing a 3D model of a home for sale and, by selecting, e.g., one or more icons, or by selecting a wall of the home, the buyer may be presented with customization options, such as removing the wall, changing the wall color, hanging virtual pictures on the wall, etc. (the buyer may be prompted to do this, e.g., in response to a realtor NPC indicating that the home has great renovation potential and providing the buyer with instructions on how to manipulate the digital representation).

In an embodiment, the seller may decide to associate a survey with one or more of his or her environments. The system may be configured for presenting the buyer with the survey specific to the environment. For example, upon selection of an environment by the buyer, the survey may be presented to the buyer, on the buyer client device 112, and completion of the survey may or may not be a prerequisite for access to the environment to be granted. If survey data is inputted by the buyer, the system includes memory 106 for storing the survey data on the server 102, or in the database 1008 accessible by the server 102. Once the survey data is stored, the system may automatically customize the environment based on the stored survey data, so that if the buyer indicated, in response to the survey, that he or she has a spouse and two children, the environment may be configured to show a virtual family of four digital NPCs “living” within the 3D digital home rendering, allowing the buyer to envision how the home would suit a family similar to their own.

In contrast to the process, described hereinbefore, whereby a buyer manually customizes aspects of an environment after access thereto, the survey may be seen to allow for automated client-based customization of an environment, which is dependent upon data manually inputted into the survey by the buyer via the client interface on the buyer client device 112, prior to environment entry by the digital buyer avatar. The survey data may be combined, at the server 102, with buyer-specific biographical information to generate the customized environment.

The seller may decide, when configuring the environment, whether or not to include a survey and, further, the seller may configure parameters specific to the survey. For example, the seller may establish whether filling out the survey is a pre-condition to granting access to the environment or whether buyers that simply “skip” the survey may continue to gain access to the environment.

In another example, the biographical information for buyer “John” may indicate that John is single, enjoys outdoor activities and enjoys spending time in his backyard. Upon selecting a potential real property to browse, John may be prompted to fill in a survey that asks, e.g., whether he is living alone, which features he considers important in a house, whether he has pets and, if so, what kind, etc. The resulting customized environment may include customizations derived from John's feedback and/or biographical information. For example, if John indicated that he has a dog, the customized environment may depict a backyard with a patio and a barbeque, as well as a dog playing in the backyard. If, on the other hand, John had indicated that he has no pets, or that he dislikes pets, then the resulting customized environment would not contain any virtual pets. In some cases, the seller may provide the option for one or more of his or her environments to allow buyers to select the customized environment, or the environment designed by the seller without the automated customization.

In some cases, buyers may be presented with a prompt message, before entry to an environment, to provide feedback regarding the product (or products) within the virtual environment (e.g., a virtual store) that interests them the most. The prompt message may appear separately from, or as part of, a survey. In these cases, the system may provide the buyer with an option to enter and browse the environment starting at a digital storefront, or to begin the exploration of the virtual environment at a location proximate to the product of interest (e.g., the system may load the digital buyer avatar next to a digital baseball card display within the virtual store, if the buyer indicated “baseball cards” to be a product of interest). This custom location-loading may take place within a survey-based customized environment, or within a seller designed, non-customized environment. In embodiments employing this feature, a seller may choose to include the prompt message for any one or more of their environments, or may decide not to use the feature at all.

In some embodiments, the system may further comprise a combination of software and hardware that allow for generating a discount of a sale price of a real product for sale within an environment, based on an outcome of a digital undertaking performed by the buyer.

The digital undertaking may be, e.g., a videogame, or a virtual quest performed by the digital buyer avatar within the virtual environment. For example, a seller may choose to include a number of “arcade-style” mini-games in his or her environment that, if completed successfully, results in a discount offer for a particular item, group of items, or all items in the environment or in all environments of the seller. A buyer's digital undertaking results may be ranked against those of other buyers, so that only those with the top scores receive special benefits or discounts. Examples of videogames that could be available include arcade-style games such as Frogger™, Tetris™, Pong™, Bejewelled™, etc. Game developers and programmers would be able to create their own games, which the game developers could sell on the secondary market as virtual assets. In one example scenario, a buyer may encounter, within the virtual environment, a virtual slot machine. By selecting the slot machine, the buyer may play a game and, depending on the outcome (e.g. all apples, or two apples and one orange, etc.), the buyer may receive a fixed value discount or percentage discount applied to the sale price of the sale item.

In addition to, or instead of, the videogames, a digital NPC may offer the buyer the opportunity to embark on a virtual quest, with the successful completion of the resulting in a discount. Virtual quests are scripted scenarios guided by digital NPCs. As an example of a virtual quest, buyer “Johnny” enters the environment “Joe's Comic Book Shack” and, while exploring the environment, Johnny finds a digital NPC in a superhero outfit. The digital NPC tells Johnny that he is going on a quest to save the world from evil and that, if Johnny helps him, he may be rewarded with a 10% discount at the store (the store being the virtual store within the environment “Joe's Comic Book Shack”). Johnny accepts the digital NPC's quest, which involves rescuing the digital NPC's lost cat (also dressed in superhero garb) from the evil neighborhood minions (grade school children that have kidnapped the cat). Johnny must now navigate his digital buyer avatar in search of the cat, interact with the virtual school children and, perhaps, even use items he finds in the environment (e.g., catnip), to complete the quest.

A quest may be carried out using a simple inventory/interaction system. For example, the buyer may have four inventory slots visually presented on the client interface, at the buyer client device 112, upon the acceptance of a quest. The digital buyer avatar may be able to “pick up” a given item within the environment by simply selecting the given item, say, by using a pointer to click on the given item within the client interface. Once picked up, the item may appear within one of the inventory slots. The digital buyer avatar may be able to use a particular item from within the inventory slots by selecting the particular item to remove the items from the inventory for use in carrying out the quest. In role playing games, quests of this nature are often referred to as “fetch quests,” although the digital undertaking may comprise other known types of quests, such as a “delivery quest,” a “gather quest,” etc. Typically, the quests comprise tasks that are easily completed, such as tasks that involve either collecting items and/or interacting with digital NPCs in order to receive rewards.

A quest may be designed by the seller via a “quest-maker” tool available to sellers using the system, or a simple scripting tool that would allow the seller to customize the positioning, animation, dialogue, etc. of digital NPCs, virtual assets, etc., as well as the quest conditions. For example, the design of a simple fetch quest could involve the following sequence of instructions: select digital NPC Location (e.g., in front of virtual store); select digital NPC Initial Dialogue (e.g., “Hello, would you like to try a quest to get 10% off your next purchase?”); select initial animation (e.g., default standing animation); select fetch item (e.g., wallet); select fetch item location (e.g., under the table); select NPC completion dialogue if quest successfully completed (e.g., “Congratulations!”); select NPC completion dialogue if quest not successfully completed (e.g., “Sorry, no dice!”); select NPC completion animation if quest successfully completed (e.g., claps hands); select NPC completion animation if quest not successfully completed (e.g., thumbs down); select reward (10% off all items in the store); select time limit on reward, if applicable (e.g., 30 minutes); select if quest is playable one time per account, or repeatable and, if repeatable, select how often the quest may be repeated (e.g., one time per account), etc. Alternatively, the quests may be freely available, ready-made default quests or quests purchased on the secondary market as virtual assets. The videogames may similarly be freely available, or purchased or traded as virtual assets.

Such digital undertakings provide incentives to prospective buyers to purchase items within an environment. The seller may configure the digital undertakings and/or discounts in a number of ways, including the type of discount offered (fixed or percentage), the amount of the discount, the number of times the undertaking may be played by a buyer (ever, or within that day, or in the next [XX] hours, etc.), and, as further incentive to commit to a purchase, the seller may make any discount that is won by a buyer time-bound (e.g. “Receive 25% off your purchase within the next 30 minutes”). It is expected that prospective buyers within an environment may be more likely to commit to a purchase if they feel engaged with the environment and/or the item or service for sale, and/or if they feel that they are getting a bargain. The digital undertakings may provide the engagement and bargains expected to facilitate sale completion.

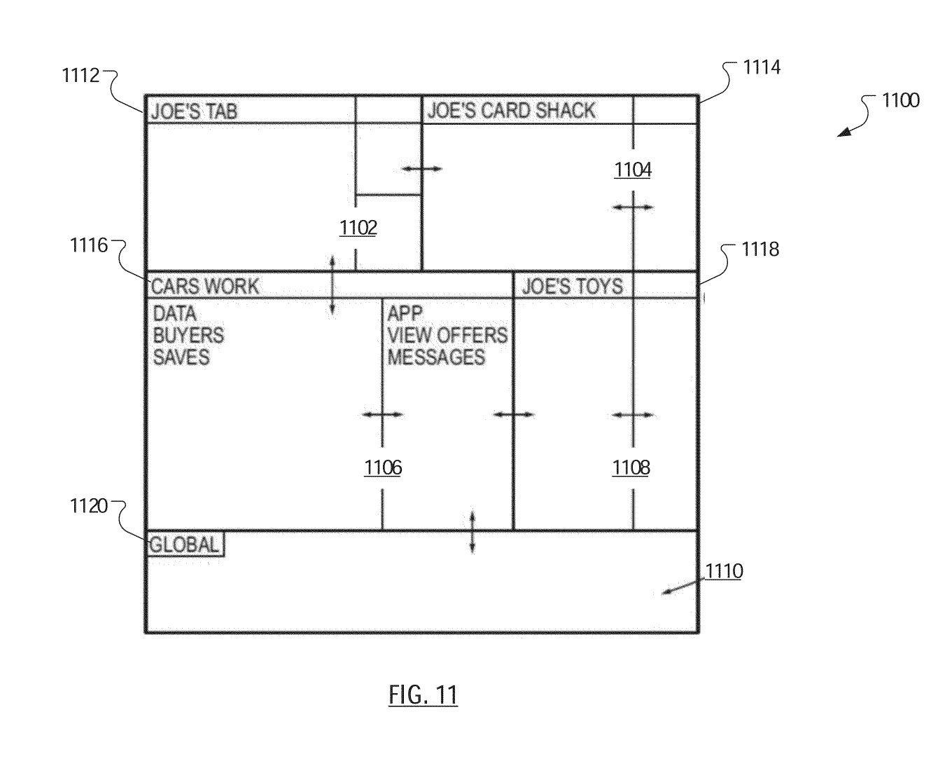

The server 102 may also be configured to serve, to the seller client device 110, a seller overview interface. Overview interfaces may be accessible only by sellers. Each seller has access to a seller-specific overview interface, an example 1100 of which is illustrated in FIG. 11. The overview interface 1100 may be configured to provide information on all environments and real products of the seller and on all buyers within the environments of the seller (e.g., the number of buyers per environment and/or the buyer profile names of each). Functions associated with one or more of the pieces of information are provided in the overview interface 1100. For example, selecting a buyer profile name may bring up a chat box for text chat between the seller and the selected buyer. The chat box may have an associated microphone icon, for example, which may be selected to initiate, or request to initiate, audio communication between the seller and the buyer. The overview interface 1100 may also permit the seller to apply global manipulations (i.e., changes to all environments of the seller), such as a global discount of 30%, which may be time-bound, e.g., to a 15 minute period. The overview interface 1100 may also permit the seller to make changes on a per environment, per item, or per buyer basis. Other variables to limit global changes, such as the number of buyers, or item type, may also be applied. For example, the seller may offer a discount to the first ten buyers in each environment, or may offer discounts for only certain types of items.

Further, an element of the overview interface 1100 may allow the seller to compose a message for broadcast to all of the buyers within the environments of the seller (e.g., “I've just applied a 30% discount to all of my virtual worlds! You've only got until 3:15 PM EST to take advantage of this amazing offer. Get 'em while they're hot!”) The seller may also configure a given message to be broadcast to all buyers within a particular environment of the seller, rather than to all buyers within all environments of the seller. Such messages are also seen, upon entry into an environment, by buyers entering the environment subsequent to the transmission of the message.

For example, the seller may be selling a car, a dining set and a flat screen television. Each of these products may have their own virtual environment. The seller may monitor all three of these environments in the overview interface and communicate, via text chat, to all buyers within any one of these environments (by a broadcast message to the buyers), or with all buyers within all three of the environments (by global broadcast messaging), or the seller may simply choose a particular buyer to send messages to, perhaps based on analytics data (described in detail hereinafter) that suggests that the buyer may be interested in purchasing the product or service. Broadcast or global broadcast messages are displayed on the client interface of all buyers currently present within, or who subsequently enter, the environment(s). Whether a buyer, who enters an environment subsequent to the broadcasting of a message to that environment, sees the broadcasted message, may depend on how much time has elapsed since the message was transmitted. In that scenario, the seller may be able to configure any such time restriction for broadcast messages, global or otherwise.

In a further embodiment, sellers may use the overview interface to create and edit environment messages. In this embodiment, the environment message does not appear within the chat box of a client interface but, instead, is presented to the buyer, on the client interface, in a more permanent manner, such that it is always visible to those browsing the environment. For example, the environment message may be displayed in an information bar along the top or side of the client interface and may state, e.g., “Welcome to my world!” A seller need not provision his or her environments with environment messages.

The overview interface 1100 may also permit sellers to edit the item lists in their respective environments (e.g., by adding or deleting sale items) and permit sellers to edit the item prices. Each environment's item list, item prices and environment message may be edited from the overview interface 1100. This gives the seller control over his or her environments, as each environment, or all environments in aggregate, may be managed and customized in real-time. Further, using the overview interface 1100, the seller may interact with buyers within his or her environments, by text or audio chat, without having to be “virtually” present within any one of his or her environments, using the digital seller avatar.

The seller may choose to include one, some, or all of the seller's virtual environments within the customizable interface of the overview interface 1100.

In the example overview interface 1100 of FIG. 11, a first virtual environment 1102 is illustrated for “Joe's Tab” and is associated with a first heading or “tab” 1112. A second virtual environment 1104 is illustrated for “Joe's Card Shack” and is associated with a second tab 1114. A third virtual environment 1106 is illustrated for “Cars Work” and is associated with a third tab 1116. A fourth virtual environment 1108 is illustrated for “Joe's Toys” and is associated with a fourth tab 1118.

A horizontally disposed box 1110 along the bottom of the overview interface 1100 displays the contents of the seller's current chat sessions. The seller may select one or more of the tabs 1112, 1114, 1116, 1118 disposed above the chat box 1110, each representing the respective environments 1102, 1104, 1106, 1108 to display the chat messages of the selected environments. Further, the seller may select a “Global” button 1120 within the chat box 1110 to view messages from all of the seller's environments. The environments, and correspondingly the messages from the environments, may be color-coded, or distinguishable from one another by some other means. The seller's current selection, e.g., the tab 1112, may also govern the environment(s) to which the seller's current messages are transmitted. Selection of more than one environment tab at a time allows the seller to broadcast messages to the buyers present in all of the selected environments. As an alternative to selecting the “Global” button 1120, the seller could individually select all of the environment tabs 1112, 1114, 1116, 1118 associated with the chat box 1110 to send a global broadcast message to all buyers within all of the seller's environments 1102, 1104, 1106, 1108.

All windows in the overview interface 1100, including the chat box 1110, may be customizable in size. As such, the seller may customize the overview interface 1100 by modifying the size of each environment's display window. Additionally, the seller may choose which digital controls to include for each environment (e.g., “apply discount”, “view offers”, etc.) and which digital controls to include on the general interface as being applicable to all environments that are selected (i.e., by selection of any of the environment tabs 1112, 1114, 1116, 1118 shown above the chat box 1110 in FIG. 11). Each window may also display particular sets of data about the respective environment, thereby allowing the seller to choose the information to be displayed for each environment.

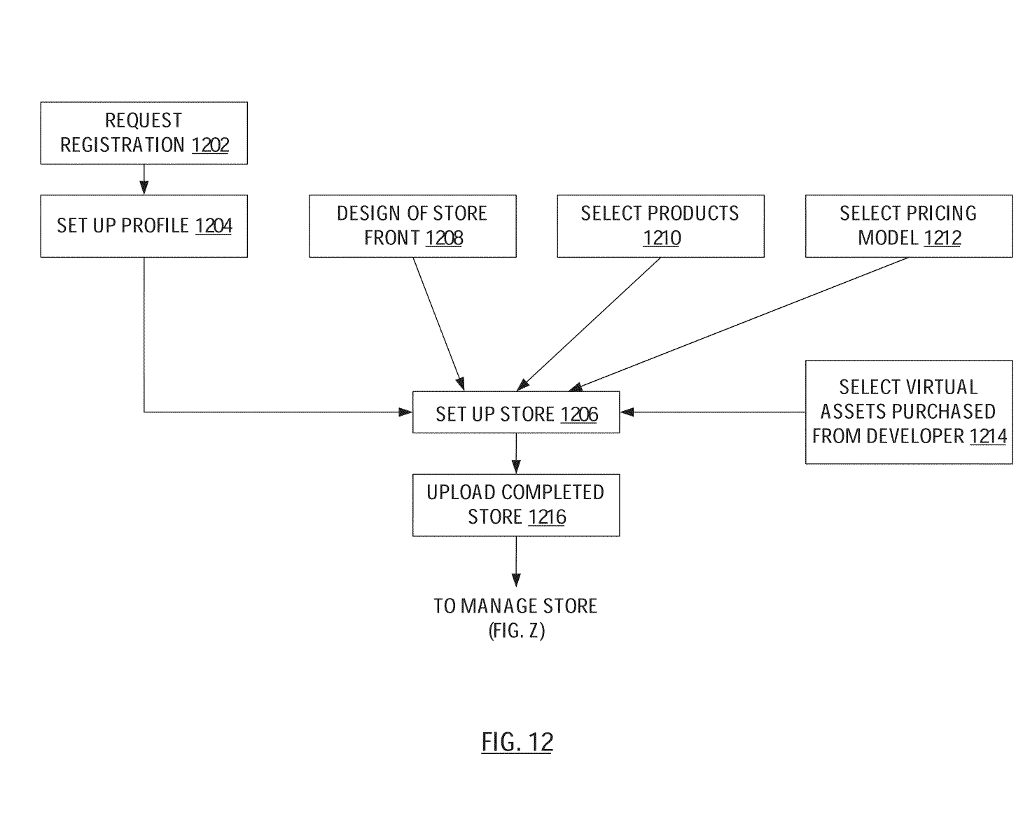

FIG. 12 schematically illustrates seller activities related to the setting up of a store. In one scenario, a seller accesses a login page served by the server 102 using a seller client interface (e.g., a web browser) on the seller client device 110 and requests (step 1202) registration of an account with the server 102. Responsive to the registration, the server 102 stores account details of the seller in the database 108. The seller, having registered, may set up (step 1204) a seller profile. Setting up (step 1204) a seller profile may include customizing the digital seller avatar, which allows the seller to be virtually present within the seller's virtual environments, if desired.

The seller may then set up (step 1206) a store. More particularly, the seller may design (step 1208), using the seller client on the seller client device 110, a store front. Designing (step 1208) the store front may involve establishing a portion of the store that will be displayed to avatars in the virtual mall. In one instance, the store front may include a room for an automatic display, under control of the server 102, of any current discounts available in the store.

The seller may also select a product or service (step 1210) to sell. The seller may upload a digital data file representative of the product or service and generate a 2D, 2.5D or 3D digital representation therefrom using known third party software available within, or to, the system. The digital representation (e.g., a data file of a 3D rendering) may be created by the seller using the system or using software external to the system. Example products include, but are not limited to, real property, vehicles, second hand goods, art, furniture and trading cards. As part of selecting the product or service (step 1210), the seller may enter a text description of the product or service and associate the product or service with a category (to facilitate searching).

The seller may also select (step 1212) a pricing model. More particularly, the seller may enter a price for the product or service. The seller may also establish discounts. Alternatively, the seller may simply indicate that offers are welcome. The setting up (step 1206) of the store may also involve selecting (step 1214) virtual assets purchased from a developer. Upon completion of the setting up (step 1206) of the store, the seller may use the seller client on the seller client device 110 to upload (step 1216) the completed store to the server 102.

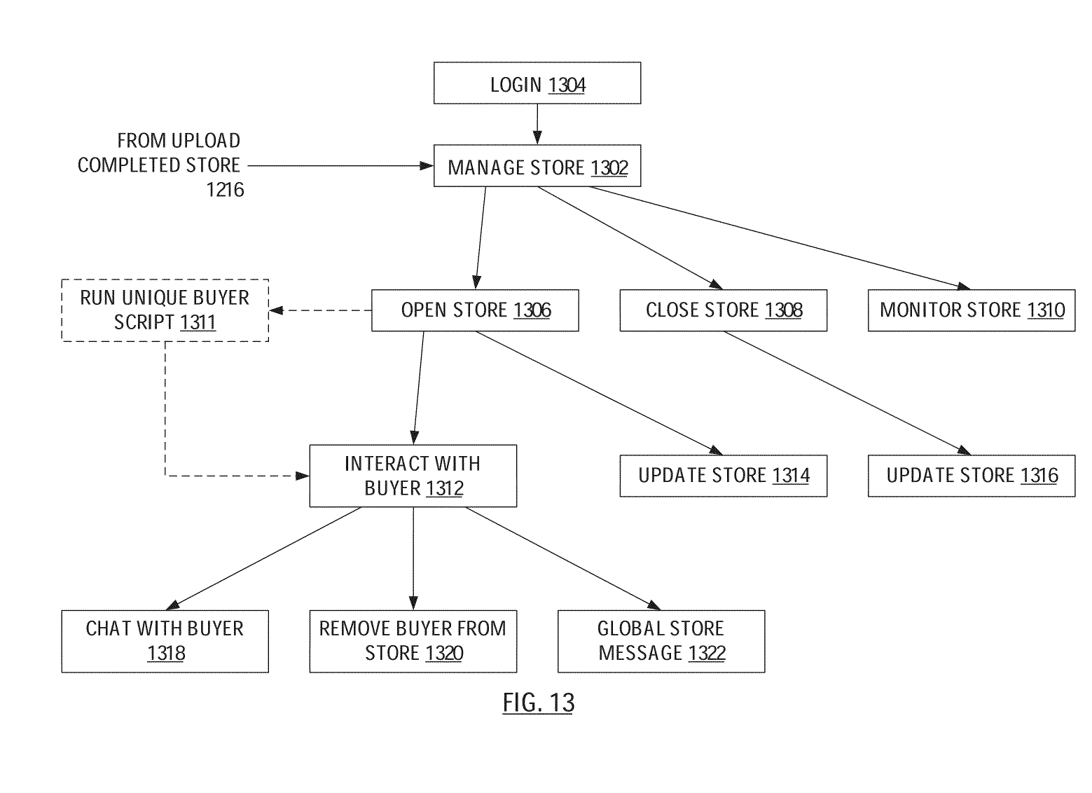

Upon uploading (step 1216) the store, the seller may proceed to manage (step 1302) the store. FIG. 13 schematically illustrates seller activities related to managing a store. As an alternative to managing (step 1302) the store immediately subsequent to uploading (step 1216) the store, the seller may initiate management (step 1302) of the store responsive to logging in (step 1304) at a later time.

Managing (step 1302) the store may, for one example, involve opening (step 1306) the store. Once the store has been opened, managing (step 1302) the store may involve interacting (step 1312) with a buyer.

Interacting (step 1312) with the buyer may involve chatting (step 1318) with the buyer, for example, by text, by audio communication or by combined audio and video communication. Alternatively, interacting (step 1312) with the buyer may involve removing (step 1320) the buyer from the store. Furthermore, interacting (step 1312) with the buyer may involve generating and transmitting (step 1322) a global store message. In such a case as generating and transmitting (step 1322) a global store message, the global store message may be individually transmitted to each buyer in the store.

Once the store has been opened, managing (step 1302) the store may involve updating (step 1314) the store. Updating (step 1314) the store may, for but a few examples, involve adding promotional material and changing pricing.

Managing (step 1302) the store may, for another example, involve closing (step 1308) the store. Once the store has been closed, managing (step 1302) the store may involve updating (step 1316) the store. Updating (step 1316) the store may, for but a few examples, involve turning on one or more discounts, turning off one or more discounts, moving products and adding new products.

Managing (step 1302) the store may, for a further example, involve monitoring (step 1310) the store. Monitoring (step 1310) the store may involve the seller watching the overview interface 1000 of FIG. 10.

In addition to selecting (step 1208, FIG. 12) a store front, the seller may, for example, select a virtual environment. The seller may select the virtual environment by selecting a virtual environment pre-built by the seller, selecting from a series of default environments available to sellers within the system (e.g., office space, street scene, local eatery, etc.), building a seller-specific virtual environment using various virtual assets (e.g., trees, light posts, front lawn, barn house, etc.) or purchasing or bartering for a virtual environment on the secondary virtual asset marketplace within the system, for use in association with the digital representation of the product. The seller may customize the virtual environment, regardless of the source, by adding, deleting, or modifying the size, colour, appearance, position, etc. of various features within the environment. For example, the seller may customize a virtual environment purchased from another seller. The environment may be given a name and may be tagged with keywords and/or item types for the items being sold therein, to facilitate buyer searches. The digital representation may be separately tagged with like keywords and may also be given a name to facilitate searching thereof.

A custom scenario may be created for the virtual environment, such as a virtual 2D, 2.5D or 3D shop with a shopkeeper, an open house in which real property may be explored, a virtual “test drive” of a vehicle, a demonstration of a cleaning service, etc. The scenario may involve one or more digital NPCs that may be seen to facilitate the sale of the product, especially when the seller is not present to answer questions from the buyers. The seller may customize the digital NPCs' dialogues, appearance and animations (e.g., the digital NPCs may be standing or working in a garden, manipulating an object, etc.). The seller may also upload digital data files (e.g., image files, video files, etc.) relating to the product or service. The seller may choose to have the digital data files displayed within the virtual environment in any number of ways. For one example, the digital data files may be displayed within the virtual environment through interaction with a digital NPC (e.g., the digital NPC may open a virtual brochure displaying uploaded image files). For another example, the digital data files may be displayed within the virtual environment on a “virtual display” in the environment (e.g., an electronic billboard or television set within a 3D rendering of a home).

The seller may choose the manner of display in addition to the place within the virtual environment the digital representation of the sale item may be displayed (e.g., the seller may place a 3D rendering of a car for sale in front of a virtual dealership or opt to have the digital representation appear in a pop-up window). Once the listing is established and saved to the database 108, the listing is available for access by potential buyers using the system 100. The listing may be considered to comprise the such elements as the virtual environment, the digital representations of the sale items, the digital NPCs, the descriptions and the keywords.

The seller may monitor activity within each of the seller's environments within the overview interface 1000 and apply global discounts (or even price increases), apply global environment customizations or send global broadcast messages to all buyers within the seller's environments. Alternatively, such discounts, customizations and messages may be applied on a per environment or per buyer basis.

From a buyer's perspective, in use, a buyer accesses a login page served by the server 102 using a buyer client interface (e.g., a web browser) on the buyer client device 112 and registers an account with the system (see FIG. 2). Responsive to the registration, the server 102 stores account details of the buyer in the database 108. The buyer, having logged in, may create a digital buyer avatar, which is used by the buyer to navigate the virtual environments. Alternatively, the buyer may select from a list of generic avatars, or may choose to purchase a pre-made avatar from the secondary virtual asset market. The buyer may later customize either the generic avatar or the purchased pre-made avatar.

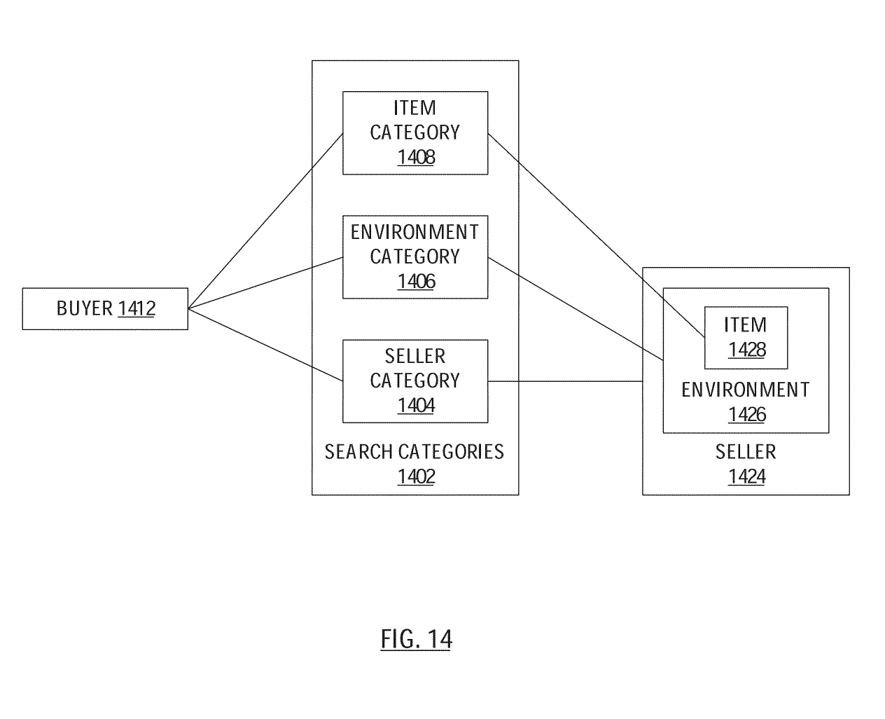

As schematically illustrated in FIG. 14, a buyer 1400 seeking a particular item 1428 may search for the particular item 1428 by searching within one of a set of search categories 1402. The search categories 1402 may include a seller category 1404, an environment category 1406 and an item category 1408. Such a search may, typically, involve use of a text search box presented on the buyer client interface (e.g., “oak table”), although other like means are possible. A search in the environment category 1406 or the item category 1408 may be a search of a name keyword, a description keyword or a type (e.g., the buyer may search for “Joe's Card Shack,” or may select “trading cards” from a nested menu of item types). The buyer may also search the seller category 1404 based on the seller name (e.g., the buyer may remember hearing from a friend that “Joe Blow” is a very reliable seller).

As illustrated in FIG. 14, the buyer 1400 may search the seller category 1404, the environment category 1406 or the item category 1408. After selecting a seller 1424, the buyer 1400 may view the seller's environments or the seller's sale items. In FIG. 14, an example environment 1426 is illustrated for the selected seller 1424. Additionally, an example item 1428 is illustrated for the example environment 1426.

After selecting the example environment 1426, the buyer 1400 may view the seller 1424 associated with the example environment 1426 or view the items 1428 for sale within the example environment 1426.

After searching for an item 1428, the buyer 1400 may view the seller 1424 who has listed the item 1428 for sale or the environment 1426 within which the item 1428 is listed.

Various means may be used to present the information described, such as nested menu expansion (e.g., clicking a seller may reveal a submenu of environments and clicking an environment may reveal a sub-submenu of item types and/or items for sale within that environment). Once the buyer 1400 selects the environment 1426 to enter, such as by double-clicking, or selecting a nested menu option (e.g., “Enter environment”), the buyer 1400 may be “transported” to the environment 1426. Once the buyer 1400 selects the item 1428, by means similar to that described hereinbefore for the selection of the environment 1426, the buyer 1400 may be transported to the environment 1426 hosting the selected item 1428.

If the buyer 1400 searches the item category 1408, search results displayed on the buyer client interface at the buyer client device 112 may comprise a listing of available items for sale. A general overview or description of each item available in the list may also be provided in a more detailed version of the listing. Responsive to the buyer 1400 selecting, from among the search results, the item of interest 1428, the buyer may be “transported” to the associated virtual environment 1426 that hosts or houses the product or service. In this way, the buyer 1400 accesses, via the digital buyer avatar, the relevant virtual environment 1426 associated with the seller 1424 who is selling the item of interest 1428, e.g., a home.

If the buyer 1400 searches the environment category 1406, a series of environments may be displayed on the client interface in the search results and the buyer 1400 may select the environment of interest 1426. Responsive to selection thereof, the buyer 1400 may either browse from the search interface (e.g., by nested menu expansion) a repository of sale items in the environment of interest 1426 or, alternatively, may enter the environment of interest 1426.

If the buyer 1400 searches the seller category 1404, a set of sellers may be displayed on the buyer client interface in the search results. The buyer 1400 may select the seller of interest 1424 and, e.g., by nested menu expansion, view the environments 1426 (e.g., “Joe's Card Shack,” “Joe's Furniture Store,” “Joe's Odds and Ends,” etc.) associated with the seller 1424 and/or view all of the items available for sale by the seller 1424.

Once transported to an environment, the digital buyer avatar may be able to navigate the virtual environment, which may include a 3D model of the home and a surrounding environment, including a garden, driveway, street, trees and shrubs, a gardener digital NPC, a realtor digital NPC and, perhaps, other virtual assets that the seller purchased or traded for, or made. If the seller is logged into the server 102, the digital seller avatar may also be present in the environment to interact with the digital buyer avatar by unrestricted dialogue (unlike the interactions with the digital NPCs, which are limited to the predefined question-response sets). The buyer may control, via the client interface, the digital buyer avatar and, accordingly, move the digital buyer avatar throughout the virtual environment, interacting with digital NPCs or, perhaps, engaging in digital undertakings within the environment in the hope of generating a discount. The buyer may view 2D, 2.5D or 3D pictures/projections/models based on digital data files loaded to the environment by the seller (e.g., on a virtual television within the 3D rendering of the home for sale).

The buyer may initiate a chat session with the seller, perhaps by text. If the seller is not presently available, the text message may be left by the buyer to be seen by the seller the next time the seller logs into the server 102, at which time the seller may respond to the inquiry. Similarly, if the buyer is offline when the response is submitted, the server 102 may save the message so that the message may be retrieved by the buyer the next time the buyer logs into the server 102. In some embodiments, audio messages may also be left by the buyer for the seller and vice versa. The buyer may, e.g., leave a message for the seller expressing his or her interest in a sale item, asking a question about the product or service for sale, requesting a price reduction, etc. In an embodiment, the server may store these messages to the database 108 so the user (buyer or seller) may review the message history at any time.

Perhaps, having customized the digital representation of the real product to the buyer's liking (e.g., changing wall colors), the buyer may be persuaded to purchase the product and, accordingly, may select the “purchase” purchase-related action, e.g., by clicking an icon presented on the buyer client interface. Alternatively, the buyer may select to make an offer to the seller or arrange to meet the seller in person, in the real world, to enter into further negotiations (although such negotiations may also take place via text or audio chat using the system 100). When customizing the environment, the seller may select a subset of purchase-related actions to make available to buyers, on a global basis (i.e., with respect to all of the seller's environments), on a per environment basis or on a per product basis. For example, for less expensive goods, a seller may not be willing to take any offers and may only make available to buyers the “purchase” purchase-related action.

The buyer may also be interested in other items within the environment and select a purchase-related action for one or more of these other items. These other items may be presented to the buyer via a textual or pictorial list, or the other items may have 2D, 2.5D or 3D digital representations within the environment.

While the digital buyer avatar is within the environment, the buyer may search the environment for items by using a search bar, by asking a digital NPC within the environment what other items are for sale (if this is one of the pre-configured questions available for asking) or by browsing the environment via the digital buyer avatar.

A buyer may also wish to search for items for sale within a certain geographic range of the buyer's present location. In an embodiment, the server 102 provides location based services, thereby allowing buyers to specify geographic search ranges when searching for items (e.g., all sale items within 10 km of the buyer's current real world location). In this manner, the server 102 provides prospective buyers with access to global markets or, if they so choose, local markets. In this embodiment, the server 102 may populate (with environments) a local virtual mall or virtual flea market, for example, having virtual storefronts for all environments selling products that are within a certain distance (e.g., 10 km) of the buyer's real-world location. In this way, the server 102 may provide a digital alternative to garage sales, malls, flea markets, etc. that is superior to the real world versions of these market places, as the virtual mall may sell only the items of interest to the buyer and, further, may comprise virtual storefronts only for those items within a desired distance in the real world. If the buyer chooses to explore a virtual mall, the buyer need only identify items or item types of interest and a distance from the buyer's current location (or, alternatively, from the buyer's home address) within which the real world products are being sold. The server 102 may, therefore, allow buyers to browse virtual malls having digital representations of products being sold in close proximity to the buyer, without the buyer ever having to actually travel anywhere in the real world.

Once the buyer enters the position information, the server 102 may auto-populate generic storefronts within one of a number of preset virtual mall designs. The buyer may move the digital buyer avatar throughout the virtual mall. The storefronts in the virtual mall may be presented in an order corresponding to the real world distance of the products being sold from the buyer's real world location. Environments selling products that are closer to the buyer's real world location may be presented closer to the virtual mall entrance, where the buyer's avatar may load when the interaction with the virtual mall begins. Environments with products located further away from the buyer's real world location may be presented further into the virtual mall.

As will be well understood by the person of ordinary skill in the art, the geographic search is only one of the ways of displaying results in a virtual mall. Indeed, a given store need not be selling items in person or have a specific degree of proximity to the buyer for the given store to be displayed in the virtual mall, if such criteria is not selected.

A seller may choose to associate a customizable banner with a virtual environment. The banner may be displayed on the storefront when the environment is included within a virtual mall. If an environment has not been provisioned with a banner by the seller, the server 102 may only present the name of the environment on the virtual storefront within the virtual mall.

The server 102 may also have a number of categories of generic virtual storefronts, each corresponding to a different product or service type. For example, if the environment “Joe's Card Shack” sells cards and memorabilia, the storefront may have some resemblance to a trading card store. Sellers may also choose to have bulletin boards, announcements, fliers and other like virtual assets virtually posted on their generic storefronts. In this way, the server 102 allows for customization of virtual storefronts generated for environments included within the virtual malls.

The server 102 may also provide the buyer with distance information when the digital buyer avatar browses the virtual mall, the distance information indicating the real world distance from the buyer's real world location (or, alternatively, from the buyer's home address) of any particular virtual store within the virtual mall. This information may, e.g., be displayed on a heads-up display (“HUD”), on the buyer client interface. The buyer client interface may also display an overview map of the virtual mall, with an indicator of the digital buyer avatar's current position within the mall.

In some embodiments, the server 102 provides means for looking up real-world directions to the real products associated with a particular environment. This may be accomplished, e.g., by clicking (e.g., right-clicking a mouse) on an environment in a search results list, or on an environment's virtual storefront within the virtual mall, and selecting a “directions” option or, alternatively, by clicking (e.g., right-clicking a mouse) anywhere on the client interface while within an environment and selecting the “directions” option. As such, the digital buyer avatar need not be within a particular environment to look up directions to the real world location of the real products associated with the environment. Alternatively, the server 102 may provide a selectable “directions” icon associated with each environment. The server 102 may integrate with third party mapping software, such as Google Maps®, to provide directions to a real world product of interest, either within the buyer client interface or in a separate browser window triggered by the server 102.

A buyer need only select a virtual storefront within the virtual mall, e.g., by clicking the virtual storefront on the client interface (e.g., by double-clicking the virtual storefront, or selecting an “enter” icon associated therewith, or by clicking a virtual door of the virtual storefront, etc.), to enter that environment. Upon selection of a virtual storefront, the digital buyer avatar may be transported to the environment and interaction with the environment may proceed as previously described. The “virtual mall” functionality is expected to benefit both buyers and sellers using the system, as buyers are more likely to purchase items in close proximity to them in the real world (thereby minimizing travel time and cost) and sellers may draw a relatively high degree of local traffic to their environments, potentially increasing sales volumes.

The virtual mall may be provisioned dynamically. Virtual environments within the virtual mall may continue to change as new environments within the specified distance, that sell the specified products or product types, continue to be created within the server 102. As new environments are created and added to the virtual mall, the buyer may be able to see the mall changing as the buyer browses the mall with the digital buyer avatar. The server 102 may provide alerts to the buyer indicating that a new virtual store has been added. The alert may include information such as the virtual store type, name, and/or location within the virtual mall.

The server 102 may also generate and store analytic information. In an embodiment, information pertaining to interactions with digital NPCs and, in particular, information identifying which of the preset dialogue questions are selected by buyers, may be saved to the database 108, thereby making available to the seller, in some embodiments in real-time, information about the types of questions asked by buyers and the respective frequencies of the inquiries (i.e., the number of times each question is asked). This information may be presented to the seller in aggregate, representing the total numbers from all buyers within one or all of the seller's environments, or on a per buyer basis, allowing sellers to gauge the level of interest of each buyer. The seller may, having gauged the interest of a particular buyer by noting his repeated inquiries over multiple visits to the environment, select that buyer from the list of buyers presently in one of his environments, and send a message to that buyer, perhaps to provide further information, or to engage in negotiations. Additionally, analytics for the entire set of buyers for the day, week, month, etc., may be extracted from the database 108. Examples of analytical information that may be extracted from the database 108 include, but are not limited to: the total number of unique visits; the number of repeat visits; interactions per digital NPC; most frequently asked questions; and the digital NPCs with which the most interactions have taken place. The stored data may be time-stamped, so that the seller, e.g., may find that the seller's scenario is explored more during the evening. As another example, the seller may determine that questions about price are the most common, or that a particular digital NPC is not being interacted with by the majority of buyers. The seller may then use this information to adjust the number/position/types of digital NPCs and make alterations to the question-response sets to create a better “sales pitch.”

In another embodiment, the buyer may save a list of the buyer's favorite sellers, as well as favorite products or services. Similarly, the seller may save a list of the seller's favorite buyers. The server 102 may also provide means for rating buyers and sellers, so that once a transaction is complete, both the buyer and seller may rate one another. These ratings may be based on a numerical scale and may use pictorial representations, such as stars in a five-star rating system. Other users of the system 100 may then base their willingness to interact with a certain buyer or seller based on the ratings provided by past users.

It is expected that the server 102 may provide for real-time interaction between buyers and sellers and/or virtual environments, including real-time customizations of virtual environments by buyers and sellers, to facilitate the purchasing process in a manner impractical in real-time in the real world. Further, the server 102 may be seen to allow each seller to create custom scenarios, using virtual assets, including digital NPCs, within their virtual environments. Such scenarios, such as that of a realtor digital NPC guiding a prospective buyer through a 3D model of a home, are expected to facilitate the sale of real products in a manner not otherwise available in present online retail solutions. The server 102 may also allow for multiple digital buyer avatars to be present and to interact with one another (such as by text or audio chat), in real time, within each virtual environment (as in a retail store in the real world in which multiple buyers browse for merchandise).

The system 100 may be seen to provide a primary market, for the sale of real goods and services, and a secondary market, for the sale of virtual assets (e.g., pre-made virtual environments, digital NPCs, etc.) that are used to facilitate the sale of the real goods and services in the primary market. There are also provided freely available virtual assets, also called “models,” such as trees, shrubs, etc., that are available for use by sellers. The system 100 not only allows for sale of the real and virtual goods and services, but also for the exchange or barter, or the free dissemination, of these goods and services. It is expected that the hybrid nature of the system 100 (i.e., its dual market for real and virtual assets) and the ability to create virtual environment scenarios (using virtual assets, such as digital NPCs) and buyer-centric customizations, interactions, and discounts, may facilitate the sale of real products and services, as sellers may be able to create truly captivating sales experiences in which buyers may explore their imaginations and inform their decisions through real-time customization and inquiry. It is further expected that, by the use of default and/or purchased virtual assets (e.g. environments, digital NPCs, etc.), sellers may be able to establish enriching virtual environments within a relatively short amount of time. Given that all virtual assets may be customized, even skilled modelers may choose to buy pre-built environments or models and then edit the environments or models to make unique environments or models, thus saving a considerable amount of time and effort.

It is to be understood that users of the server 102 registered as sellers may also use the server 102 as buyers, with their respective digital buyer avatars, to browse or purchase items of other sellers.

It may also be understood that, although various means for digital interaction and manipulation have been described herein, other means capable of achieving the same ends are within the scope of the present disclosure. For example, the client device may comprise a laptop or desktop computer, tablet, smart phone, personal digital assistant (“PDA”), videogame console, etc. The buyer client device and/or the seller client device may comprise virtual reality (VR) technology, such as VR head gear (e.g., the Oculus Rift™), which may also include VR body gear to facilitate movement of avatars and their appendages within the virtual environments. Such body gear may also comprise haptic technology to provide the buyer with tactile feedback when “touching” virtual assets within the virtual environment. Further, the client interface need not be limited to screen displays or VR, but instead, or additionally, may comprise holographic technologies that visually present the virtual environments in three-dimensional physical space or in two-dimensional physical space in a manner that makes the virtual environment appear three-dimensional. It is expected that use of technologies permitting more realistic representations of the virtual environments, such as VR technology or holography, may afford buyers an experience comparable to physically inspecting the sale items in the real world. Other means for human-machine interaction are also possible.

It is expected that the system 100, while useful for the sale of various real products and services, may be especially useful for advertising and selling real estate properties. The ability to upload digital image or video files depicting the house and to generate, using automated rendering software, a 3D model of the home, as well as the ability to customize the virtual environment with interactive digital NPCs for answering questions and providing guided tours, a potential buyer may gain the full experience of an open house, without ever leaving the comfort of his or her own home. Further, the buyer may explore the house visually, learn about its features through interactions with, e.g., a realtor digital NPC, and customize the 3D house rendering (e.g., by changing wall colors, removing walls, changing kitchen counters and cabinets, adding or removing furniture, pictures, etc.), all in real-time. The prospective buyer may also benefit from a depiction of a “family” of digital NPCs, living in the home, that is comparable to the family of the prospective buyer (as determined by survey data and/or biographical information associated with the buyer), thereby allowing the buyer to effectively visualize how well the home would accommodate a family comparable in size to his or her family. Such virtual family depictions and real-time customization, are not practical in present online retail solutions and are not practical in real world open houses. In a typical open house in the real world, a seller markets a particular “image” of the house that typically appeals to most people (e.g., using neutral color schemes and staging the home with generic furniture and art work). With the addition of automated survey-based customization and/or manual buyer customization, a virtual open house may be created that caters to each buyer's specific preferences and/or circumstances. Further, owners of homes are often absent from open houses, whereas sellers using the server 102, if logged in, may be directly communicated with by the buyers within the environment.

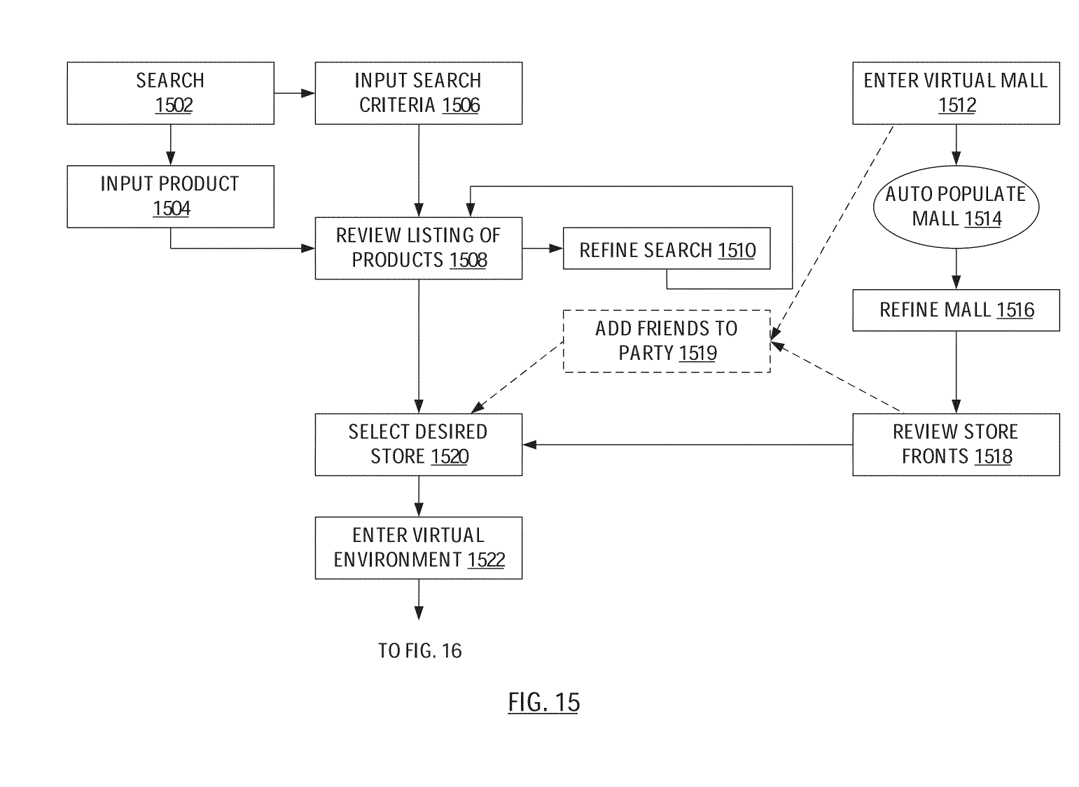

FIG. 15 illustrates example buyer activity related to shopping in a virtual environment. Two pathways to entering a virtual environment (store) are illustrated. One of the pathways may be considered to be a search-initiated pathway initiated by the buyer searching (step 1502). The other one of the pathways may be considered to be a mall-entry-initiated pathway initiated by the buyer entering (step 1512) into a virtual mall, that is, a mall populated with storefronts associated with virtual environments consistent with the teachings of the present application.

In the search-initiated pathway (step 1502), the buyer may, in a case wherein a specific product or service is sought, input (step 1504) details of the specific product or service. Alternatively, the buyer may, in a case wherein only general keywords related to the product or service are known to the buyer, input (step 1506) search criteria describing the specific product or service. Responsive to either type of search, the buyer may review (step 1508) a presentation of a listing of products. Such a presentation of a listing of products may be familiar to anyone with experience with searching a present-day online shopping site (e.g., Amazon.com™). If the buyer determines that the listing of products is too lengthy for the buyer to review relevant results, the buyer may refine (step 1510) the search and review (step 1508) a presentation of a refined listing of products. Upon settling on a particular product, the buyer may select (step 1520) a store, that is, a store that sells the particular product. Responsive to receiving a mouse click or some other manner of selecting the store, the buyer may enter (step 1522) the selected store's virtual environment.

In the mall-entry-initiated pathway, the mall into which the buyer enters (step 1512), may be based around a generic skeleton mall structure that has slots for housing storefronts. The server 102 may, responsive to receiving an indication of the buyer's entry into the mall, auto populate (step 1514) the mall. Auto-population of the mall may, for example, take into account aspects of the buyer's profile. That is, the server 102 may auto populate the mall with stores that satisfy pre-established buyer criteria. The server 102 may also auto populate the mall with stores based on a purchase history associated with the buyer's profile. Auto-population of the mall may, for another example, take into account aspects of the buyer's search criteria. Indeed, responsive to a buyer searching for running shoes, the server 102 may auto populate (step 1514) the mall with stores containing running shoes. The virtual mall may, in one instance, be auto populated exclusively with running shoe stores and may, in another instance, be auto populated with running shoe stores and other stores, with running shoe stores receiving priority. The buyer may choose a “garage store” only search, in which only physically close stores that are willing to meet in person will be displayed. The buyer may, alternatively, choose to refine the stores based on location, best match and other criteria.

After having been presented with the auto populated mall, the buyer may choose to refine (step 1516) the mall by choosing to filter the types of store fronts to be displayed or by removing some store fronts and adding other store fronts. The buyer may then proceed to review (step 1518) the store fronts.

The digital buyer avatar in the virtual mall environment may perceive that other digital buyer avatars are also shopping within the same virtual mall. A single virtual mall may be formed, for example, for all buyers looking for similar items or all buyers having a similar buying history and, accordingly, having a similarly auto-populated mall. Notably, even though the virtual malls perceived by individual buyers may be similar, it is unlikely that any two virtual malls are identical. That is, each buyer may perceive unique storefronts due to profile-based auto population and buyer refinement. As such, while the avatars in the virtual mall may see each other, at one particular mall location user a buyer named “Bob” may see a storefront associated with a store called “John's hardware store” and a buyer named “Allan” may see a storefront associated with a store called “Home Depot” or a storefront associated with a store called “Rick's electronics.” Because the mall storefronts are generic, the only difference presented to all users in that particular virtual mall may be the names/logos on the storefronts.

While browsing the virtual mall, the buyer may select (step 1520) a store. Responsive to receiving a mouse click or some other manner of selecting the store, the buyer may enter (step 1522) the selected store's virtual environment. Furthermore, the buyer, before selecting (step 1520) the selected store, may form a shopping party. Such shopping party formation may begin with the buyer adding (step 1519) a friend to a shopping party. As the buyer enters (step 1522) the selected store's virtual environment, members of the shopping party, if there is one, associated with the buyer may be prompted to also enter the selected store's virtual environment. Notably, the buyer may add (step 1519) a friend to a shopping party upon entering (step 1512) the virtual mall.

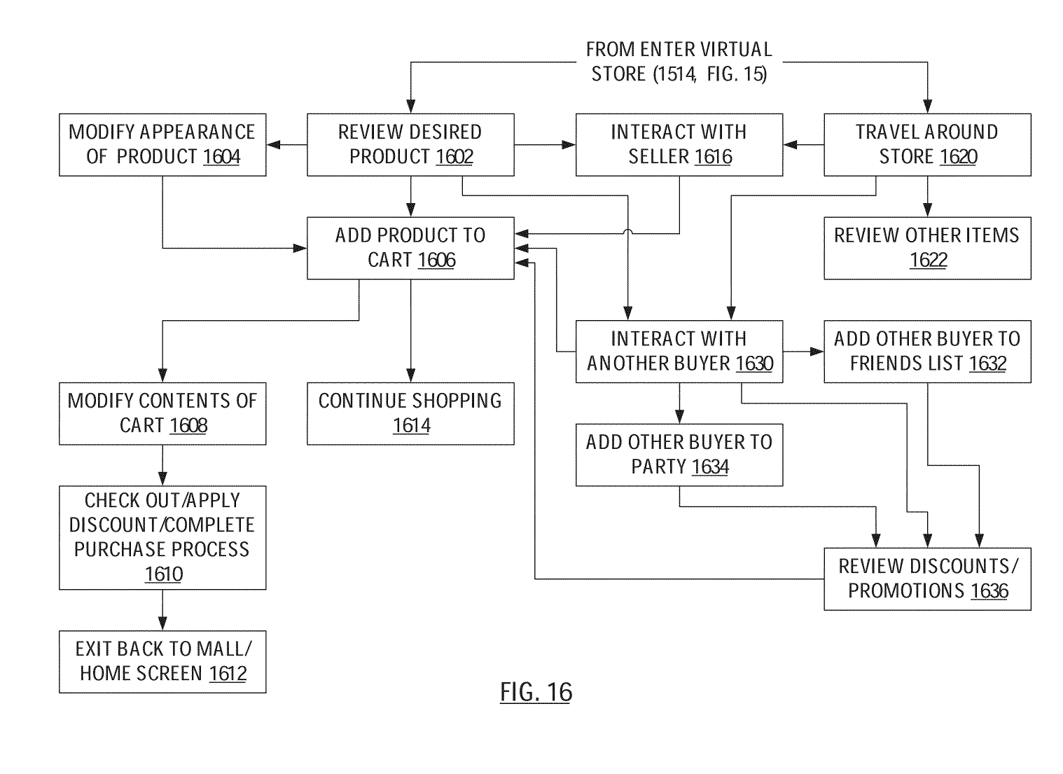

FIG. 16 illustrates example buyer activity related to shopping in a virtual environment after the buyer has entered (step 1522) the selected store's virtual environment. The buyer's activity may differ in dependence upon whether a specific product or service is sought or whether the buyer prefers to browse.

If the buyer is seeking a particular product, the buyer may proceed, upon entering (step 1522) the selected store's virtual environment, to review (step 1602) the product. After having reviewed (step 1602) the product, the buyer may add (step 1606) the product to an electronic shopping cart in a manner that should be familiar to online shoppers. Alternatively, before adding (step 1606) the product to the cart, the buyer may modify (step 1604) the product. Such modifying (step 1604) of the product may include choosing to customize a particular aspect of the product. Aspects of the product may include, for but a few examples, color, pattern and size.

The buyer may also engage in several other activities before adding (step 1606) the product to the cart. Such activities may include interacting (step 1616) with the seller of the product or interacting (step 1630) with other buyers in the virtual environment. Upon interacting (step 1630) with other buyers, the buyer may elect to add (step 1634) one or more of the other buyers to a shopping party. The buyer may also elect to add (step 1632) one or more of the other buyers to a list of friends. The list of friends may be part of the buyer's profile. Subsequent to interacting (step 1630) with other buyers, the buyer may then proceed to add (step 1606) the product to the cart. Additionally, the buyer may review (step 1636) discounts and/or promotions related to the product of interest, or other products, and then make the decision to add (step 1606) a product to the cart.

If the buyer prefers to browse, the buyer may proceed, upon entering (step 1522) the selected store's virtual environment, to travel (step 1620) around the selected store's virtual environment. That is, the buyer may guide, using the buyer client interface executed on the buyer client device, the digital buyer avatar to travel (step 1620) around the selected store's virtual environment. While travelling (step 1620) around the selected store's virtual environment, the buyer may review (step 1622) various products on display in the selected store's virtual environment. Furthermore, the buyer may interact (step 1616) with the seller associated with the selected store's virtual environment or interact (step 1630) with other buyers in the virtual environment. Upon interacting (step 1630) with other buyers, the buyer may elect to add (step 1634) one or more of the other buyers to a shopping party. The buyer may also elect to add (step 1632) one or more of the other buyers to a list of friends. Subsequent to interacting (step 1630) with other buyers, the buyer may then proceed to review (step 1636) discounts and/or promotions related to the various products on display and then make the decision to add (step 1606) a product to the cart.

Benefits of forming a shopping party may include receipt of group shopping discounts applied to purchases by party members shopping at the same store together. Buyers in the virtual mall can speak in a general chat and try to recruit members (step 1519, FIG. 15) to their shopping party to receive maximum discounts. A rating system may be employed where buyers in a shopping party may rate each other based on any number of factors including but not limited to: co-operation; timeliness; and purchase amount. Buyers that contribute to the greatest extent to a shopping party's overall discount may also receive ratings automatically on this factor.

With at least one product in the cart, the buyer may modify (step 1608) the contents of the cart. Such modifying (step 1608) may involve, for example, removing a product from the cart or altering the quantity of a product that is to be purchased. The buyer may then proceed to check out (step 1610). Checking out (step 1610) may involve completing the purchase process, where such completion may involve applying a discount to the purchase price and providing or confirming a method of payment. Discounts, such as those reviewed in step 1636 are applied at check out for the entire party.

It may be established that a group shopping discount will only be applied responsive to a threshold number or percentage of individuals in a given shopping party choosing to check out (step 1610). Where the threshold is 100%, that is, in the case wherein all members of the shopping party are to check out before a group shopping discount applies, the server 102 may transmit a message to non-checked-out shopping party members responsive to a lower threshold number or percentage of shopping party members having checked out. The message may indicate that the non-checked-out members need to check out within a specified time period or the transaction does not go through. A voting system could be employed to “kick” a given shopper out of the shopping party if the given shopper is not responding or not responding fast enough. The entire process can be repeated again from the point of being able to add more products. Once satisfied, a “check-out” may then be initiated again (either with new party members invited to replace those already there, or with the remaining members).

With at least one product in the cart, the buyer may continue shopping (step 1614)

It may be understood by the person of skill in the art that the expression “real-time,” as it is used herein, does not necessarily mean “instantaneous.” “Real-time,” as that phrase is used herein, includes the time required to digitally transmit and process server-bound requests and client-bound responses, as well as any intermediate processing steps required to fulfill a request, such as a database query, image rendering, etc. It may further be understood that references herein to the selection of features of the system may be accomplished in any of a number ways known to those of skill in the art, such as by left or right-clicking a mouse or trackpad, by selecting a feature by touch (using a finger, stylus, etc.) on a touchscreen, by voice command, by double-clicking a mouse, by selecting an icon, by virtual reality interaction, etc.

The above-described implementations of the present application are intended to be examples only. Alterations, modifications and variations may be effected to the particular implementations by those skilled in the art without departing from the scope of the application, which is defined by the claims appended hereto.

1-46. (canceled)

47. A server in a computer-based interactive marketplace system for the sale, over a network, of an item by a seller to a buyer having access to a buyer client device, the server including a processor and a memory, the memory storing programming executable by the processor such that the computer is programmed to:
generate a digital representation of the item;
generate a digital environment, the virtual environment accessible by the buyer over the network by a buyer client interface executed on the buyer client device, the virtual environment comprising the digital representation of the item;
manipulate, in accordance with first instructions received via the buyer client interface, the virtual environment;
generate, in accordance with second instructions received via the buyer client interface, a digital buyer avatar representative of the buyer, the digital buyer avatar for navigating the digital environment;
allow for digital interaction, in accordance with third instructions received via the buyer client interface, between the digital buyer avatar and the digital environment; and
carry out a purchase-related action, in accordance with fourth instructions received via the buyer client interface.

48. The server of claim 47 wherein the digital representation of the item is a three-dimensional digital rendering of the item.

49. The server of claim 47 wherein the server is further programmed to:
generate, in accordance with instructions received over the network from a seller client interface executed on a seller client device, a digital seller avatar representative of the seller;
include the digital seller avatar in the digital environment; and
provide real-time digital interaction between the digital buyer avatar and the digital seller avatar.

50. The server of claim 47 wherein the server is further programmed to:
generate a digital non-player character;
include the digital non-player character in the digital environment; and
provide digital interaction between the digital buyer avatar and the non-player character.

51. The server of claim 47 wherein the server is further programmed to:
associate the digital environment with an attribute;
receive, via the buyer client interface, a search term; and
determine a match between the search term and the attribute.

52. The server of claim 47 wherein the server is further programmed to alter, according to fifth instructions received from the buyer client interface, the digital representation of the item.

53. The server of claim 47 wherein the server is further programmed to:
transmit, to the buyer client interface, a survey specific to the digital environment, the survey comprising a survey question;
receive survey data input by the buyer via the buyer client interface in response to the survey question; and
storing the survey data.

54. The server of claim 47 wherein the server is further programmed to alter the digital environment to include virtual assets.

55. The server of claim 54 wherein the server is further programmed to allow for digital interaction between the seller and another seller.

56. The server of claim 47 wherein the server is further programmed to:
receive digital data files via a seller client interface; and
insert the digital data files into the digital environment, thereby making the digital data files available for later access via the buyer client interface.

57. The server of claim 47 wherein the purchase-related action comprises an action selected, via the buyer client interface, from a set of purchase-related actions and the server is further programmed to alter, responsive to instructions received from a seller client interface, the set of purchase-related actions available to the buyer within the digital environment.

58. The server of claim 47 wherein the server is further programmed to generate a discount of a sale price of the item based on an outcome of a digital undertaking performed by the buyer.

59. The server of claim 47 wherein the server is further programmed to serve an overview interface to the seller client device, the overview interface capable of providing information on the digital environments and the item and on the buyer.

60. The server of claim 47 wherein the server is further programmed to allow the buyer to form a shopping party by associating the buyer with a further buyer.

61. The server of claim 47 wherein the server is further programmed to generate a digital storefront representative of, and associated with, the digital environment.

62. The server of claim 61 wherein the server is further programmed to:
generate a virtual mall environment, the virtual mall environment including the digital storefront; and
populate the virtual mall environment with a plurality of other digital storefronts.

63. A method for offering for sale, over a network, a real product or service by a seller to a buyer having access to a client device, the method comprising:
receiving, at a server, first item-related instructions;
generating, at the server and according to the first item-related instructions, a digital representation of an item;
receiving, at the server, environment-related instructions;
generating, at the server and according to the environment-related instructions, a digital environment, the digital environment arranged to:
present the digital representation of the item;
receive second item-related instructions from a buyer client interface executed on a buyer client device; and
alter, at the server and according to the second item-related instructions, the digital representation of the item.

64. The method of claim 63 further comprising:
receiving, at the server from the client interface, avatar-related instructions; and
generating, at the server and according to the avatar-related instructions, a digital buyer avatar.

65. The method of claim 63 wherein the digital environment is further arranged to allow navigation of the digital environment by the digital buyer avatar.

66. The method of claim 63 wherein the item comprises one of a real product and a service.

67. The method of claim 63 further comprising forming a shopping party by associating the buyer with a further buyer.

68. The method of claim 63 further comprising generating a digital storefront representative of, and associated with, the digital environment.

69. The method of claim 68 further comprising:
generating a virtual mall environment, the virtual mall environment including the digital storefront; and
populating the virtual mall environment with a plurality of other digital storefronts.

70. The method of claim 69 wherein the populating the virtual mall environment comprises populating in accordance with search criteria received via the buyer client interface.

71. The method of claim 70 wherein the search criteria includes a criterion related to a distance from a real-world location associated with the buyer.

72. A server in a computer-based interactive marketplace system for the sale, over a network, of an item by a seller to a buyer having access to a buyer client device, the server comprising:
a memory;
a processor programmed to:
receive first item-related instructions;
generate, according to the first item-related instructions, a digital representation of an item;
receive environment-related instructions;
generate, according to the environment-related instructions, a digital environment, the digital environment arranged to:
present the digital representation of the item;
receive second item-related instructions from a buyer client interface executed on a buyer client device; and
alter, according to the second item-related instructions, the digital representation of the item.
